(19) United States
(12) Patent Application Publication
(10) Pub. No.: US 2008/0145705 A1
(43) Pub. Date: Jun. 19, 2008

(54) Material for Organic Electroluminescent Element and Organic Electroluminescent Element Employing the Same

(76) Inventors: Harunori Narihiro, Tokyo (JP); Michiko Tamano, Tokyo (JP); Nozomi Tsushima, Tokyo (JP)

Correspondence Address: MCDERMOTT WILL & EMERY LLP, 600 13TH STREET, N.W., WASHINGTON, DC, 20005-3096, US

(21) Appl. No.: 10/566,950

(22) PCT Filed: Jul. 29, 2004
(86) PCT No.: PCT/JP2004/010836

§ 371 Date: Feb. 3, 2006

(30) Foreign Application Priority Data
Aug. 5, 2003 (JP) 2003-286948

(51) Int. Cl. C09K 11/06; B32B 27/06; C08G 67/00

(52) U.S. Cl. 428/704; 252/301.35; 528/423; 528/392

(57) ABSTRACT

A material for organic electroluminescent elements which comprises a copolymer comprising; units each comprising a main chain having a trivalent unconjugated organic residue and a monovalent organic residue bonded to the main chain through a structure comprising two or more groups conjugately bonded to each other; and units each having an amino group.

### TECHNICAL FIELD

The present invention relates to a material for organic electroluminescent elements and an organic electroluminescent (EL) element employing the same with high luminous efficiency.

### BACKGROUND ART

A large number of electroluminescent (EL) elements employing an organic substance have been under development in such applications as cheaper wide-area and full-color display elements of the solid-phase emission type. Generally, the organic electroluminescent elements consist of a light-emitting layer and a pair of parallel electrodes holding the layer between them. Electroluminescence is a phenomenon that, when an electric field is applied between the electrodes, electrons are injected from the cathode and holes from the anode, and the electrons recombine with the holes in the light-emitting layer to emit the energy as light at the time when the energy level changes from the conduction band to the valence band.

Conventional organic electroluminescent elements had higher driving voltage and lower luminescence brightness and luminous efficiency than inorganic electroluminescent (EL) elements. In addition, the deterioration of properties thereof is also significantly faster. Therefore, they were not commercialized. An organic electroluminescent element having laminated thin films containing an organic compound having a high fluorescence quantum efficiency that emits light at a low voltage of 10 V or less was reported and attracting attention recently (see e.g., Nonpatent Document 1 below). In the element, a metal chelate complex was used in the light-emitting layer and an amine compound in the hole injection layer, and the element emits a high-brightness green light such as a brightness of several thousands cd/m² under a DC voltage of 6 to 7V. However, the element has a problem in the productivity that in preparing organic electroluminescent elements, the layer of the organic compound has to be formed by the vapor deposition. It is preferable that the preparation of layers is formed by coating, for simplification of the production process and corresponding to expansion of the element area.

As emitting materials for organic electroluminescent elements used in production of organic electroluminescent elements by the coating method which is advantageous in productivity, there are known conjugated polymer emitting materials such as polyphenylene vinylene polymer (see e.g., Nonpatent Documents 2 and 3 below). However, the polyphenylene vinylene polymers have light-emitting units in the polymer main chain, and it makes difficult to control the concentration of the emitting material therein. Therefore, the polyphenylene vinylene polymer has problems such as difficulty in delicate controlling of color tones and emission intensity. In the same manner, another organic electroluminescent element prepared by the coating process, which uses a colorant-dispersed polymer, is known. A typical example of the elements using the colorant-dispersed polymer is an element containing, for example, a low-molecular weight colorant dispersed in polyvinylcarbazole (see e.g., Patent Document 1 below). In the element using a colorant-dispersed polymer, it is possible to use various materials having a function such as an electron transportation, electron injection, hole transportation, hole injection, or light emission property by mixing in the luminescent element.

On the other hand, as polyvinylcarbazole has a high glass transition point, it has a relatively higher durability. However, polyvinylcarbazole has practical problems such as a higher driving voltage, lower luminous efficiency based on an insufficient hole mobility, and a lower film-forming property. Various carbazole-derived polymers and copolymers were proposed to overcome the problems inherent to polyvinylcarbazole. For example, copolymers of a carbazole derivative and an diamine derivative (see e.g., Patent Documents 2 and 3 below), copolymers of a carbazole derivative and an oxadiazole derivative (see e.g., Patent Documents 4 to 7 below), and polymer shaving other carbazole units with a special constitution (see e.g., Patent Documents 8 to 10) are known, but all of these polymers are lower in luminance and luminous efficiency and shorter in lifetime.

Patent Document 1: Japanese Patent Application Laid-Open (JP-A) No. 4-212286

### Patent Document 2: JP-A No. 2002-124390

### Patent Document 3: JP-A No. 2002-37817

### Patent Document 4: JP-A No. 11-60660

### Patent Document 5: JP-A No. 11-307253

### Patent Document 6: JP-A No. 2000-159846

### Patent Document 7: JP-A No. 2001-126875

### Patent Document 8: JP-A No. 2002-105445

### Patent Document 9: JP-A No. 2002-363227

### Patent Document 10: JP-A No. 2002-302516

Nonpatent Document 1: Appl. Phys. Lett., Vol. 51, pp. 913-915, 1987

### Nonpatent Document 2: Polymer Bulletin, Vol. 38, pp. 167-176, 1997

### Nonpatent Document 3: Macromolecules, Vol. 32, pp. 1476-1481, 1999

The driving voltage of the colorant-dispersed element employing polyvinylcarbazole or the derivative polymer thereof is higher than that of the organic electroluminescent elements employing a conjugated polymeric emitting material, for example, a polyphenylene vinylene derivative. It is probably because the carrier mobility of the unconjugated polymer materials used in the colorant-dispersed element is lower than that of the conjugated polymeric luminescent materials such as a polyphenylene vinylene derivative. Driving voltage, which directly reflects the power consumption of display device, is a noteworthy property, and there exists a need for reduction of the driving voltage of the colorant-dispersed elements employing polyvinylcarbazole or the derivative polymer thereof.

### DISCLOSURE OF INVENTION

An object of the present invention, which was made under the circumstances above, is to provide an organic electroluminescent element lower in driving voltage and higher in luminous efficiency, and a material for organic electroluminescent elements used in the element.

In addition to the above object, an object of the present invention is to provide a material for organic electroluminescent elements superior in film forming property when the organic electroluminescent element is formed by coating or printing and allowing formation of a film superior in durability, and an organic electroluminescent element superior in durability and quality.

The objects of the present invention are achieved by using a copolymer containing a unit represented by the following Formula [1] and an amino group-containing unit as the polymer used in the material for organic electroluminescent elements.

That is, the present invention relates to the material for organic electroluminescent elements described in items 1 to 6 below and the organic electroluminescent element described in item 7 below.

1. A material for organic electroluminescent elements, characterized by including a copolymer having the unit represented by the following General Formula [1] and an amino group-containing unit.

### General Formula [1]:

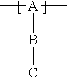

wherein A represents an unconjugated trivalent organic residue; B represents a bivalent organic residue formed by binding conjugately two or more groups selected from the group consisting of substituted or unsubstituted arylene groups and substituted or unsubstituted heteroarylene groups to each other; and C represents a monovalent organic residue represented by the General Formula [2]):

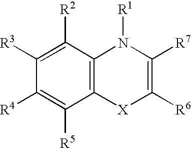

wherein R¹ to R⁷ each represents a binding unit, a hydrogen atom or a substituent; X represents a direct bond, —O—, —S—, —Se—, —NH—, —NR⁸— (R⁸ represents an alkyl or aryl group.), —S(═O)₂—, —CO—, —COO—, —OCO—, or —CH₂—; and R¹-R⁷ may bind to each other to form an aryl ring that may have additionally substituents.

2. The material for organic electroluminescent elements described in item 1, being characterized in that the monovalent organic residue represented by General Formula [2] is a monovalent organic residue represented by the following General Formula [3].

### General Formula [3]:

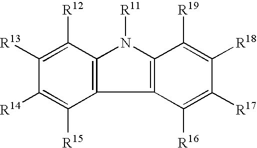

wherein R¹¹ to R¹⁹ each represents a binding unit, a hydrogen atom or a substituent).

3. The material for organic electroluminescent elements described in item 1 or 2, being characterized in that the copolymer further has a unit represented by the following General Formula [7].

### General Formula [7]:

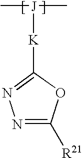

wherein J represents an unconjugated trivalent organic residue; K represents a direct bond, a bivalent organic residue selected from the group consisting of substituted or unsubstituted arylene groups and substituted or unsubstituted heteroarylene groups, and a bivalent organic residue formed by binding two or more groups selected from the group consisting of the substituted or unsubstituted arylene groups, the substituted or unsubstituted heteroarylene groups, and substituted or unsubstituted ethenylene groups to each other, and if the substituted or unsubstituted ethenylene group is used, the ethenylene group is put between the arylene group(s) and/or heteroarylene group(s); and R²¹ represents a hydrogen atom or a substituent.

4. The material for organic electroluminescent elements described in any one of items 1 to 3, being characterized in that the copolymer has additionally at least one unit selected from a unit derived from N-vinylcarbazole or a N-vinylcarbazole derivative, a unit derived from styrene or a styrene derivative, a unit derived from (meth) acrylic acid or a (meth)acrylic acid derivative, a unit derived from maleic acid or a maleic acid derivative, and a unit derived from an organic acid vinyl ester.

5. The material for organic electroluminescent elements described in any one of items 1 to 4, further including a luminescent material capable of emitting light based on the triplet exciton.

6. The material for organic electroluminescent elements described in any one of items 1 to 5, further including an electron transporting material.

7. An organic electroluminescent element having, between a pair of electrodes, a light-emitting layer or multiple layers of organic compound thin films including a light-emitting layer, wherein at least one of the layers contains the material for organic electroluminescent elements described in any one of items 1 to 6.

### EFFECTS OF THE INVENTION

The copolymer having a unit represented by General Formula [1] and an amino group-containing unit and the copolymer having additionally a unit derived from N-vinylcarbazole or the derivative thereof as the copolymerization unit are superior in light-emitting property and hole transporting efficiency. In addition, the copolymer above having a unit represented by General Formula [7] additionally as the copolymerization unit is superior in light-emitting property and hole transporting efficiency as well as in electron transporting efficiency. Further, it is possible to adjust the physical properties of these copolymers by containing additionally a unit derived from styrene or the derivative thereof, (meth)acrylic acid or the derivative thereof, maleic acid or the derivative thereof, or an organic acid vinyl ester as the copolymerization unit in the copolymers. By the adjustment of the comonomer, it is possible, for example, to form a coated film superior in film forming property such as smoothness easily. In addition, these copolymers are also superior in heat resistance and stability in the thin film state. Therefore, the copolymer according to the present invention is a material favorable as the emitting material, hole transporting material, electron transporting material, and others for organic electroluminescent elements; and it is possible to form an electroluminescent element lower in driving voltage and higher in luminous efficiency by using the material for organic electroluminescent elements according to the present invention alone or in combination with other materials.

### DETAILED EXPLANATION OF THE INVENTION

The material for organic electroluminescent elements according to the present invention characteristically contains a copolymer having the unit represented by General Formula [1] above and an amino group-containing unit, and the organic electroluminescent element according to the present invention characteristically uses a material for organic electroluminescent element containing the copolymer as a layer constituent material of the element.

In the copolymer unit represented by General Formula [1], the group A represents an arbitrary trivalent organic residue forming an unconjugated main-chain skeleton and having groups B and C on the side chain. The trivalent group of group A capable of forming an unconjugated main-chain skeleton is, for example, a group represented by the following General Formula [8].

### General Formula [8]:

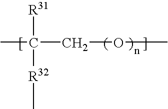

wherein R³¹ represents a hydrogen atom, a methyl group or —CN; R³² represents a direct bond, —CH₂—, —CH₂O—, —O—, —COO— or —CONH—; and n is 0 or 1.

Examples of the trivalent organic residues represented by General Formula [8] are shown below by the following Formulae E-1 to E-12, but the groups A are not limited thereto.

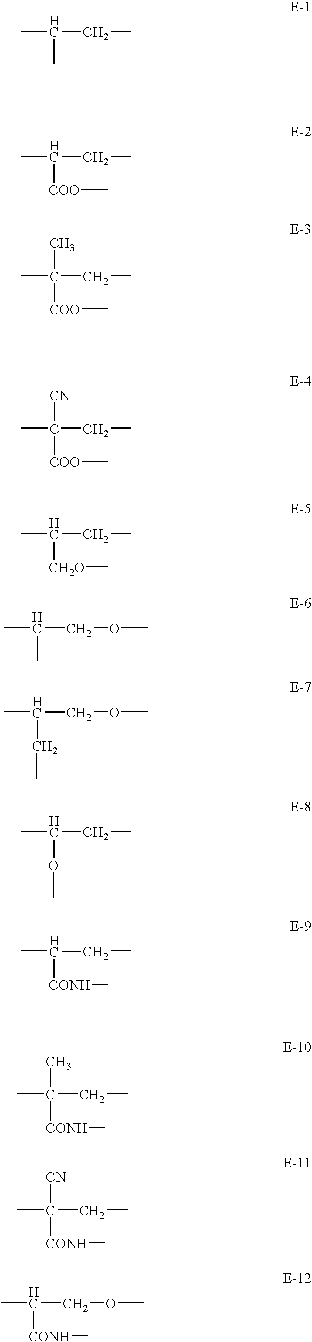

The group B in General Formula [1] represents a bivalent organic residue formed by binding conjugately two or more groups selected from the group consisting of a substituted or unsubstituted arylene group and a substituted or unsubstituted heteroarylene group to each other. The unsubstituted arylene group capable of constituting part of the group B is preferably a monocyclic or fused arylene group having 6 to 60 carbon atoms, more preferably an arylene group having 6 to 40 carbon atoms, and still more preferably having 6 to 30 carbon atoms. Typical examples thereof include phenylene, naphthalenediyl, anthracenediyl, phenanthrolinediyl, pyrenediyl, triphenylenediyl, benzophenanthrolinediyl, perylenediyl, pentaphenylenediyl, pentacenediyl, and the like. And typical example soft he substituted arylene group include the arylene groups above with substituent (s).

Alternatively, the unsubstituted heteroarylene group is preferably a monocyclic or fused aromatic heterocyclic group having 4 to 60 carbon atoms, more preferably a monocyclic or fused aromatic heterocyclic group having 4 to 60 carbon atoms containing at least one nitrogen, oxygen or sulfur atom, still more preferably a five- or six-membered aromatic heterocyclic group having 4 to 30 carbon atoms. Typical examples of the aromatic heterocyclic groups include pyrrolediyl, furanediyl, thienylene, pyridinediyl, pyridazinediyl, pyrimidinediyl, pyrazinediyl, quinolinediyl, isoquinolinediyl, cinnolinediyl, quinazolinediyl, quinoxalinediyl, phthalazinediyl, pteridinediyl, acridinediyl, phenazinediyl, phenanthrolinediyl, and the like; and typical examples of the substituted heteroarylene group include the heteroarylene groups above with substituent (s).

Examples of the substituent on the arylene and heteroarylene groups include halogen atoms (e.g., fluorine, chlorine, bromine, and iodine atoms), substituted or unsubstituted alkyl groups, substituted or unsubstituted alkoxy groups, substituted or unsubstituted thioalkoxy groups, a cyano group, an amino group, mono- or di-substituted amino groups, a hydroxyl group, a mercapto group, substituted or unsubstituted aryloxy groups, substituted or unsubstituted arylthio groups, substituted or unsubstituted aryl groups, and substituted or unsubstituted hetero-aryl groups. In addition, the neighboring substituents may bind to each other to form a substituted or unsubstituted ring. Examples of the rings formed by binding of the neighboring substituents include five- to seven-membered aliphatic, carbocyclic aromatic, heterocyclic aromatic, and heterocyclic rings that may contain oxygen, nitrogen, sulfur, or other atom. These rings may have other substituents on an arbitray position.

Among the substituents above, examples of the substituted or unsubstituted alkyl groups include methyl, ethyl, propyl, butyl, sec-butyl, tert-butyl, pentyl, hexyl, 2-ethylhexyl, heptyl, octyl, isooctyl, stearyl, trichloromethyl, trifluoromethyl, cyclopropyl, cyclohexyl, 1,3-cyclohexadienyl, 2-cyclopenten-1-yl, and 2,4-cyclopentadien-1-ylidenyl groups, and the like.

Examples of the substituted or unsubstituted alkoxy groups include methoxy, ethoxy, propoxy, n-butoxy, sec-butoxy, tert-butoxy, pentyloxy, hexyloxy, 2-ethylhexyloxy, stearyloxy, and trifluoromethoxy groups and the like.

Examples of the substituted or unsubstituted thioalkoxy groups include methylthio, ethylthio, propylthio, butylthio, sec-butylthio, tert-butylthio, pentylthio, hexylthio, heptylthio, and octylthio groups and the like.

Examples of the mono- or di-substituted amino groups include methylamino, dimethylamino, ethylamino, diethylamino, dipropylamino, dibutylamino, diphenylamino, bis(acetoxymethyl)amino, bis(acetoxyethyl)amino, bis(acetoxypropyl)amino, bis(acetoxy butyl)amino, and dibenzylamino groups and the like.

Examples of the substituted or unsubstituted aryloxy groups include phenoxy, p-tert-butylphenoxy, and 3-fluorophenoxy groups and the like.

Examples of the substituted or unsubstituted arylthio groups include phenylthio and 3-fluorophenylthio groups and the like.

Specific examples of the substituted or unsubstituted aryl groups include phenyl, biphenylenyl, triphenylenyl, tetraphenylenyl, 3-nitrophenyl, 4-methylthiophenyl, 3,5-dicyanophenyl, o-, m- and p-toluoyl, xylyl, o-, m- and p-cumenyl, mesityl, pentalenyl, indenyl, naphthyl, anthracenyl, azulenyl, heptalenyl, acenaphthylenyl, phenanthrenyl, fluorenyl, anthryl, anthraquinonyl, 3-methylanthryl, phenanthryl, pyrenyl, chrysenyl, 2-ethyl-1-chrysenyl, picenyl, perylenyl, 6-chloroperylenyl, pentaphenyl, pentacenyl, tetraphenylenyl, hexaphenyl, hexacenyl, rubicenyl, coronenyl, trinaphthylenyl, heptaphenyl, heptacenyl, pyranthrenyl, and ovalenyl groups and the like.

Typical examples of the substituted or unsubstituted heteroaryl groups include thionyl, furyl, pyrrolyl, imidazolyl, pyrazolyl, pyridyl, pyrazinyl, pyrimidinyl, pyridazinyl, indolyl, quinolyl, isoquinolyl, phthalazinyl, quinoxalinyl, quinazolinyl, carbazolyl, acridinyl, phenazinyl, furfuryl, isothiazolyl, isoxazolyl, furazanyl, phenoxazinyl, benzothiazolyl, benzoxazolyl, benzimidazolyl, 2-methylpyridyl, and 3-cyanopyridyl groups and the like.

Favorable substituents on the arylene and heteroarylene groups are, for example, alkyl or alkoxy groups having 1 to 20 carbon atoms, a phenyl group, a cyano group, and the like.

The group B may be any bivalent organic residue as long as it is a bivalent organic residue formed by bonding conjugately the two or more groups selected from the group consisting of substituted or unsubstituted arylene groups and substituted or unsubstituted heteroarylene groups to each other directly or indirectly, for example, via an ethenylene group. That is, the group B in General Formula [1] of the present invention is a bivalent group formed by direct binding of two or more group selected from substituted or unsubstituted arylene groups and substituted or unsubstituted heteroarylene groups, or a bivalent group formed by mutual binding of the arylene or heteroarylene groups, for example, via an ethenylene group as needed. If the arylene or heteroarylene group has substituents, the substituents may bind to each other to form an additional ring. Hereinafter, exemplified are some of the basic skeletons of the bivalent organic residues formed by two or more groups selected from the group consisting of substituted or unsubstituted arylene groups and substituted or unsubstituted heteroarylene groups that are bound to each other directly or via an ethenylene group. The group B in the present invention is, of course, not limited to the following examples or the groups having the following basic skeleton additionally substituted with substituent (s). And examples of the ethenylene group include ethenylene, 1-methylethenylene, and 1-ethylethenylene groups and the like.

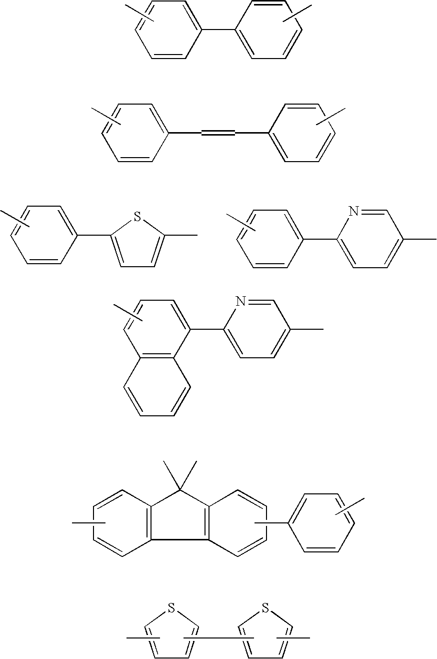

The group C in General Formula [1] is a group represented by General Formula [2] above and preferably a group represented by General Formula [3] above. Examples of the substituents of R¹ to R⁷ and R¹¹ to R¹⁹ in General Formulae [2] and [3] include groups similar to the substituents on the arylene or heteroarylene group above. Favorable examples of the groups represented by General Formula [2] or [3] are shown below, but the group represented by General Formula [2] or [3] is not limited to the following examples.

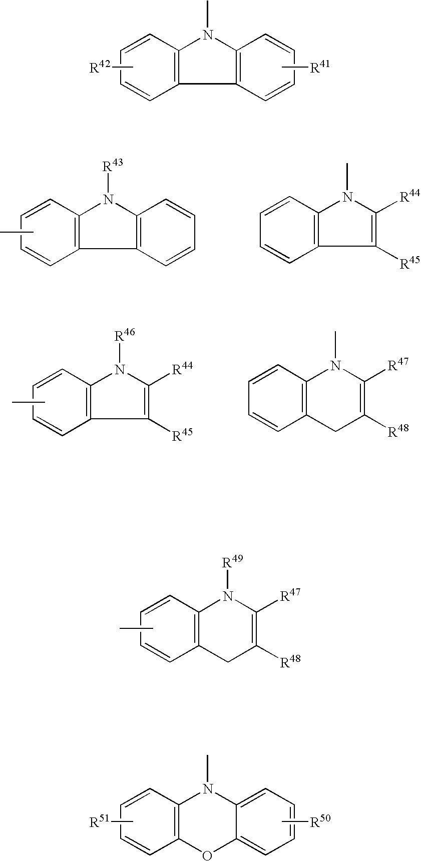

In formulae above, R⁴¹ to R⁵¹ each represents a hydrogen atom or a substituent; and the substituent includes groups similar to R¹ to R⁷ and R¹¹ to R¹⁹. Favorable examples of the substituents of R⁴¹ to R⁵¹ include alkyl groups such as methyl and ethyl; alkoxy groups such as methoxy and ethoxy; substituted amino groups such as dimethylamino; and aryl groups such as phenyl.

On the other hand, the amino group in the amino group-containing unit constituting the copolymer according to the present invention is present on the main or side chain of the copolymer. The amino group-containing unit preferably has a structure represented by the following General Formula [4] in the unit.

### General Formula [4]:

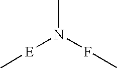

wherein E and F each independently represent a bivalent organic residue selected from the group consisting of substituted or unsubstituted arylene groups and substituted or unsubstituted heteroarylene groups, or a bivalent organic residue formed by binding of two or more groups selected from the group consisting of the substituted or unsubstituted arylene groups, the substituted or unsubstituted heteroarylene groups, and the substituted or unsubstituted ethenylene groups, and when the substituted or unsubstituted ethenylene group is selected, the ethenylene group is put between the arylene group(s) and/or the heteroarylene group(s).

More preferably, it has a structure represented by the following General Formula [5] in the unit.

### General Formula [5]:

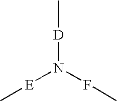

wherein D, E, and F each independently represent a bivalent organic residue selected from the group consisting of substituted or unsubstituted arylene groups and substituted or unsubstituted heteroarylene groups, or a bivalent organic residue formed by binding of two or more groups selected from the substituted or unsubstituted arylene groups, the substituted or unsubstituted heteroarylene groups, and the substituted or unsubstituted ethenylene groups, and when the substituted or unsubstituted ethenylene group is selected, the ethenylene group is put between the arylene group(s) and/or the heteroarylene group(s).

The amino group-containing unit is more preferably a unit represented by the following General Formula [6].

### General Formula [6]:

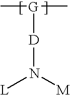

wherein D represents the group defined above; L and M each represents a monovalent organic residue selected from the group consisting of substituted or unsubstituted aryl groups and substituted or unsubstituted hetero-aryl groups; and G represents an unconjugated trivalent organic residue.

The group G in General Formula [6] above includes groups similar to those of the group A in General Formula [1] above. Examples of the substituted or unsubstituted arylene and substituted or unsubstituted heteroarylene groups of the groups D, E, and Fin General Formulae [4] to [6] include groups similar to the substituted or unsubstituted arylene and substituted or unsubstituted heteroarylene groups of the group Bin General Formula [1]. Examples of the substituted or unsubstituted aryl and substituted or unsubstituted hetero-aryl groups of the groups L and M in General Formula [6] include groups similar to the substituted or unsubstituted aryl and substituted or unsubstituted hetero-aryl groups of the group B in General Formula [1]. The substituent on the aryl or hetero-aryl group in the groups L and M may be a substituted or unsubstituted aryl group, a substituted or unsubstituted hetero-aryl group, or an alkyl group substituted with such an aryl or hetero-aryl group. Examples of the ethenylene group of the groups D, E, and F in General Formulae [4] to [6] include ethenylene, 1-methylethenylene, and 1-ethylethenylene groups and the like.

Favorable examples of the units represented by General Formula [6] include the units H-1 to H-12 shown in the following. However, the units represented by General Formula [6] are not limited to the following units.

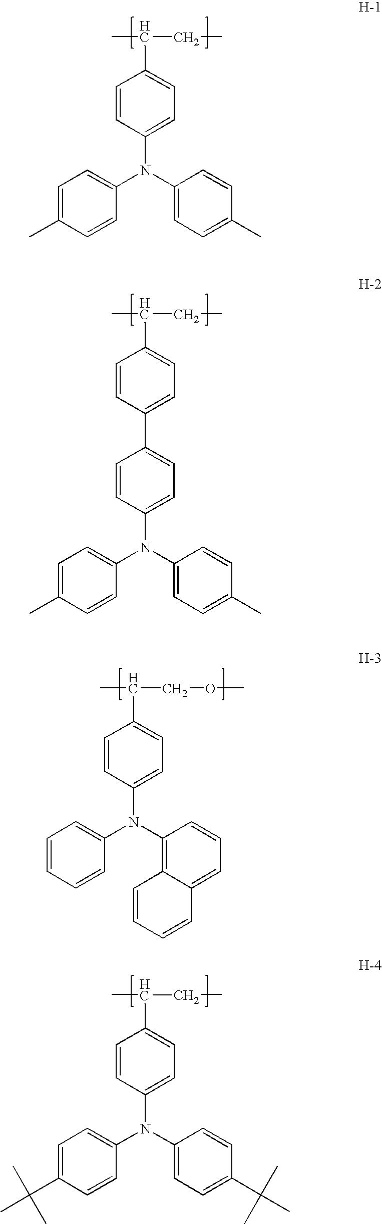

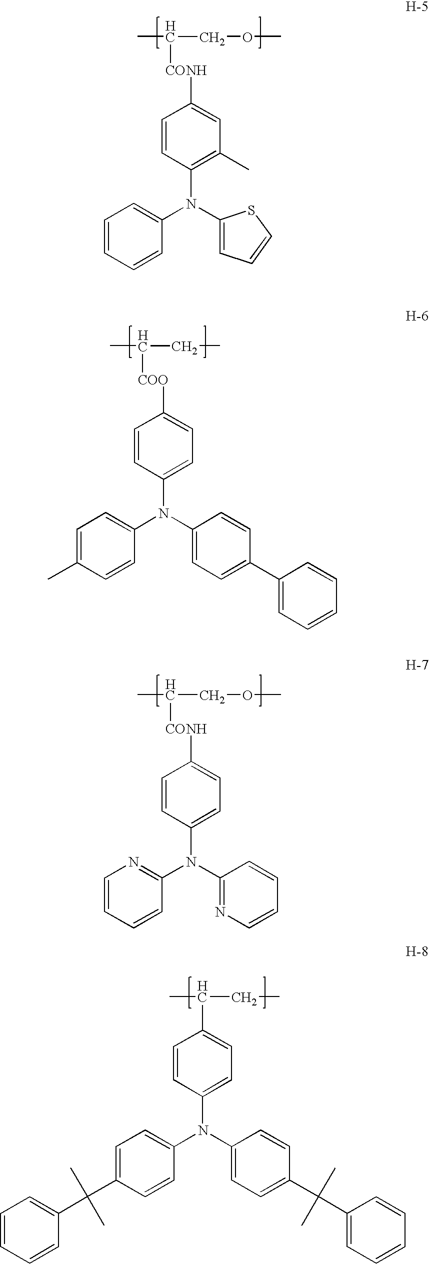

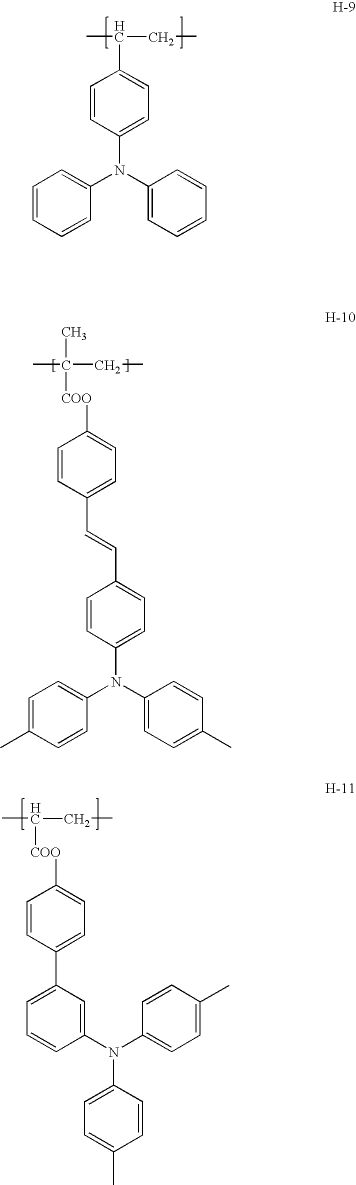

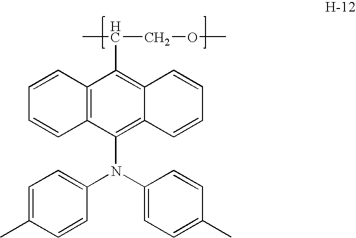

The unit represented by General Formula [1] and the unit containing the amino group are essential as the copolymer units in the copolymer according to the present invention. The copolymerization ratio of the unit represented by General Formula [1] to the amino group-containing unit is preferably 0.1:99.9 to 99.9:0.1 and more preferably 5:95 to 95:5 by molar ratio. The copolymer having these units may have additionally the unit represented by General Formula [7] above, the unit derived from N-vinylcarbazole or an N-vinylcarbazole derivative, the unit derived from styrene or the styrene derivative, the unit derived from (meth) acrylic acid or the derivative thereof, the unit derived from maleic acid or the derivative thereof, and/or the unit derived from the organic acid vinyl ester, as its copolymerization units. The content of the unit represented by General Formula [7] is normally, 90 mol % or less, for example approximately 5 to 70 mol %, in the copolymer. Alternatively, the content of the unit derived from N-vinylcarbazole or an N-vinylcarbazole derivative is 90 mol % or less, preferably 70 mol % or less, and for example approximately 5 to 60 mol %, in the copolymer. In addition, the copolymerization ratios of the unit derived from styrene or styrene derivatives, the unit derived from (meth) acrylic acid or the derivative thereof, the unit derived from maleic acid or the derivative thereof, and the unit derived from an organic acid vinyl ester in the copolymer are arbitrary as long as they are in the range able to achieve the object of the present invention, but are normally 50 mol % or less and, for example, approximately 1 to 40 mol %.

Examples of the units derived from N-vinylcarbazole or the derivative thereof include the unit represented by the following General Formula [9].

### General Formula [9]:

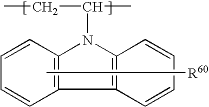

wherein R⁶⁰ represents one or more substituents and the multiple substituents, when present, may be same or different from each other. Examples thereof include a hydrogen atom and substituted or unsubstituted alkyl, alkoxy, amino, aryl and hetero-aryl groups.

Favorable examples of N-vinylcarbazole or the derivatives thereof include N-vinylcarbazole, N-vinyl-3,6-dimethylcarbazole, N-vinyl-3,6-diethylcarbazole, N-vinyl-3,6-diphenylcarbazole, N-vinyl-3-methylcarbazole, N-vinyl-3-ethylcarbazole, N-vinyl-3-phenylcarbazole, and the like.

Examples of the units derived from styrene or the derivative thereof include the units represented by the following General Formula [10].

### General Formula [10]:

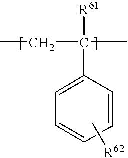

wherein R⁶¹ represents a hydrogen atom or a methyl group; and R⁶² represents one or more substituents, that may be same or different form each other when multiple substituents are present, and specifically a substituted or unsubstituted alkyl, alkoxy or aryl group.

Favorable examples of styrene or the derivatives thereof include styrene, α-methylstyrene and alkyl substituted styrenes, such as styrenes substituted with a methyl, ethyl, n-butyl, or tert-butyl group.

Examples of the units derived from (meth)acrylic acid or the derivative thereof include the unit represented by the following General Formula [11].

General Formula [11]:

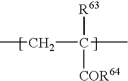

wherein R⁶³ represents a hydrogen atom or a methyl group; R⁶⁴ represents —OR⁶⁵ or —NR⁶⁶ R⁶⁷, in which R⁶⁵, R⁶⁶ and R⁶⁷ each represent a hydrogen atom and a substituted or unsubstituted alkyl or aryl group; and R⁶⁶ and R⁶⁷ may be same or different from each other.

Favorable examples of the (meth) acrylic acid or the derivatives thereof include acrylic acid, methacrylic acid, methyl acrylate, ethyl acrylate, butyl acrylate, methyl methacrylate, ethyl methacrylate, butyl methacrylate, acrylamide, methacrylamide, N- or N,N-alkyl- or aryl-substituted derivatives of acrylamide and methacrylamide, and the like.

Examples of the units derived from maleic acid or the derivatives thereof include the unit represented by the following General Formula [12].

### General Formula [12]:

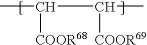

wherein R⁶⁸ and R⁶⁹ may be same or different from each other, and each represent a hydrogen atom or a substituted or unsubstituted alkyl or aryl group.

Examples of the maleic acid or the derivatives thereof include maleic acid, monomethyl maleate, dimethyl maleate, diethyl maleate, diphenyl maleate, and the like.

Examples of the units derived from an organic acid vinyl ester include the unit represented by the following General Formula [1,3].

General Formula [13]:

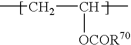

wherein R⁷⁰ represents a substituted or unsubstituted alkyl or aryl group.

The organic acid vinyl ester is favorably, for example, vinyl acetate.

Examples of the substituents of the substituted or unsubstituted alkyl or aryl group of R⁶², R⁶⁴ to R⁷⁰ in General Formulae [9] to [12] above include the groups described as the substituents on the arylene group or heteroarylene group of the group B in General Formula [1].

In General Formula [7], the group J represents an arbitrary trivalent organic residue capable of forming an unconjugated main-chain skeleton having the group K and an oxazolyl group on the side chain, and examples of the trivalent organic residues of group J include groups similar to the group A in General Formula [1] and group G in General Formula [6] above. The group A in General Formula [1], the group G in General Formula [6], and the group J in General Formula [7] may be same or different from each other. The group K in General Formula [7] represents a direct bond, a substituted or unsubstituted arylene group, a substituted or unsubstituted heteroarylene group, or a bivalent organic residue in combination of the groups above and an ethenylene group. Examples of the substituted or unsubstituted arylene group and the substituted or unsubstituted heteroarylene groups constituting the group K include groups similar to the substituted or unsubstituted arylene group and the substituted or unsubstituted heteroarylene group of the group B in General Formula [1]. As the ethenylene groups, groups similar to those described in General Formulae [4] to [6] are exemplified. In addition, examples of the substituent of R²¹ in General Formula [7] include groups similar to the groups described as the substituents of the substituted or unsubstituted arylene group and the substituted or unsubstituted heteroarylene group in General Formula [1].

Each of the copolymers used in the material for organic electroluminescent elements according to the present invention is prepared by polymerization of the monomers corresponding to respective unit. When the copolymer is prepared, the polymerization of the monomers forming the unconjugated main-chain skeleton may be conducted by any one of suitable methods such as vinyl polymerization including radical polymerization, cationic polymerization and anionic polymerization, condensation polymerization, ring-opening polymerization, and other various polymerization reactions. That is, the polymerization method in preparing the copolymer of the present invention is not particularly limited. However, a copolymerization by vinyl polymerization is particularly preferable in the present invention.

When the copolymer is prepared by the vinyl polymerization, for example, normal radical polymerization, there is used a known radical polymerization initiator, for example, an azo compound such as azobisisobutylonitrile (AIBN), a peroxide such as benzoyl peroxide (BPO), or a dithiocarbamate derivative such as tetraethylthiuram disulfide as the polymerization catalyst. Alternatively when the copolymer is prepared by living radical polymerization, a living radical polymerization method of using a catalyst system, for example in combination of an N-oxy radical such as 2,2,6,6-tetramethyl-1-piperidine-N-oxide (TEMPO) and the radical polymerization initiator above; a living radical polymerization method by atom transfer polymerization; or the like may be used. The amount of the radical polymerization catalyst used is 1 to 0.00001 mole per mole of the monomer. Examples of the polymerization solvents used in radical polymerization include amide solvents such as dimethylformamide, dimethylacetamide, and N-methylpyrrolidone; hydrocarbon solvents such as benzene, toluene, xylene, hexane, and cyclohexane; ester solvents such as γ-butylolactone and ethyl lactate; ketone solvents such as cyclohexyl benzophenone, cyclohexanone, 2-ethylpentanone, and ethyl isoamyl ketone; ether solvents such as cyclic ethers including tetrahydrofuran and aliphatic ethers including diethylene glycol dimethylether; and the like. The reaction temperature is, for example, 0 to 200° C., and the reaction time is, for example, 0.5 to 72 hours.

Examples of the polymerization catalysts used, when the copolymer is prepared by the normal anionic polymerization, include organic metal compounds of an alkali or alkali-earth metal, for example, alfin catalysts such as naphthyl sodium; alkyl lithiums such as methyl lithium, ethyl lithium, and butyl lithium; aryl lithiums such as phenyl lithium; alkyl zincs such as diethyl zinc; ate complexes such as lithium alkyl magnesium and lithium alkyl barium; and the like. Alternatively, when the copolymer is prepared by the living anionic polymerization, butyl lithium, for example, may be used as the catalyst for polymerization. The amount of the anionic polymerization catalyst used is normally 0.1 to 0.00001 mole per mole of the monomer. Examples of the polymerization solvents used in these polymerizations include hydrocarbons such as benzene, toluene, hexane, heptane, and cyclohexane; ether compounds such as tetrahydrofuran and dioxane; and the like. The reaction temperature is, for example, −50 to 100° C., and the reaction time is, for example, 5 minutes to 24 hours.

When the compound is prepared by the normal cationic polymerization, a Lewis acid such as trifluoroborate or tin tetrachloride, an inorganic acid such as sulfuric acid or hydrochloric acid, and a cation-exchange resin may be used as the polymerization catalyst. Alternatively in the living cationic polymerization, HI, HI—ZnI₂, or the like may be used as the catalyst. The amount of the cationic polymerization catalyst used is 0.01 to 0.00001 mole per mole of the monomer. Examples of the polymerization solvents used in the cationic polymerization method include halogenated hydrocarbons represented by methylene chloride and chlorobenzene; cyclic ethers such as dibutyl ether, diphenyl ether, dioxane and tetrahydrofuran; highly polar solvent such as acetonitrile and nitrobenzene; and the like. The reaction temperature is, for example, −150 to 150° C., and the reaction time is, for example, 0.01 to 12 hours.

The monovalent organic residues formed by the group B and the group C in General Formula [1], the organic residue containing an amino group when the amino group in the amino group-containing unit is present on the side chain, the monovalent organic residue formed by the group K and the oxadiazole group in General Formula [7], and the like may not be introduced in the phase of unconjugated main-chain skeleton monomer. That is, the residues may be introduced and formed by modification after the unconjugated main-chain skeleton is formed.

The copolymer according to the present invention having the unit represented by General Formula [1] and an amino group-containing unit may be a random, block, or graft copolymer, or alternatively, a polymer having an intermediate structure thereof, for example, a random copolymer having a partial block structure. Further, the copolymer containing the unit represented by General Formula [7], the unit derived from N-vinylcarbazole or the derivative thereof, styrene or the derivative thereof, acrylic acid or the derivative thereof, maleic acid or the derivative thereof, the organic acid vinyl ester, or the like that may be introduced into the copolymer additionally as a copolymerization unit may also be a random, block, or graft copolymer, or alternatively, a polymer having an intermediate structure polymer thereof, for example, a random copolymer having a partial block structure.

Considering the heat resistance characteristic and the stability in the thin film state of the copolymer used in the material for organic electroluminescent elements according to the present invention, the weight-average molecular weight thereof, as determined by gel permeation chromatography (GPC) using polystyrene standards, is preferably 1,000 to 1,000,000, and particularly preferably 3,000 to 500,000. However, the weight-average molecular weight of the copolymer used in the material for organic electroluminescent elements according to the present invention is not limited to the range above.

Typical examples of the copolymer units and the copolymer structure constituted by the copolymer units are summarized in Table 1 below, but the copolymer used in the material for organic electroluminescent elements according to the present invention is not limited to the following typical examples. Table 1 shows only the structure of each unit monomer, but not the polymer form. In addition, “%” in the Table means “wt %”.

TABLE 1
P-1

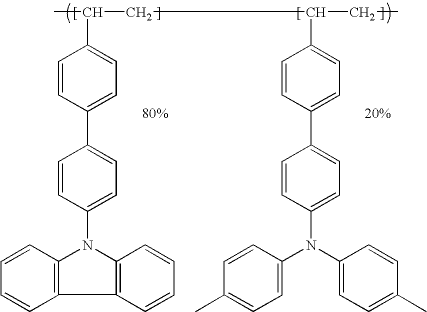

P-2

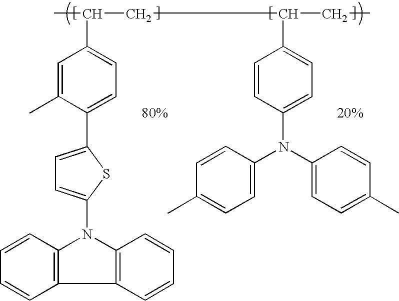

P-3

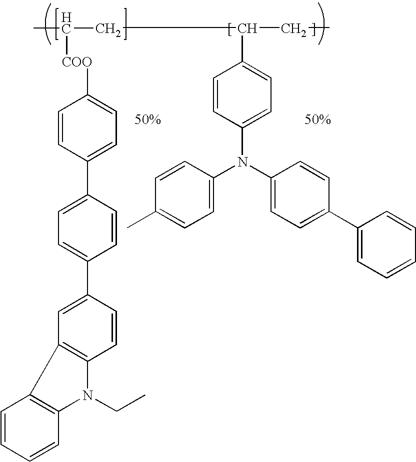

P-4

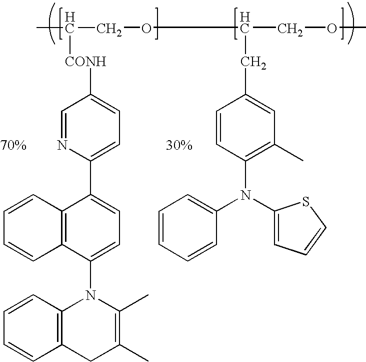

P-5

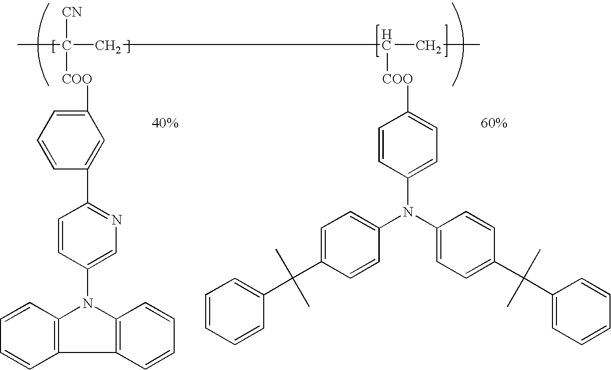

P-6

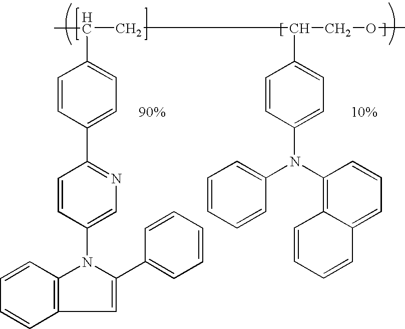

P-7

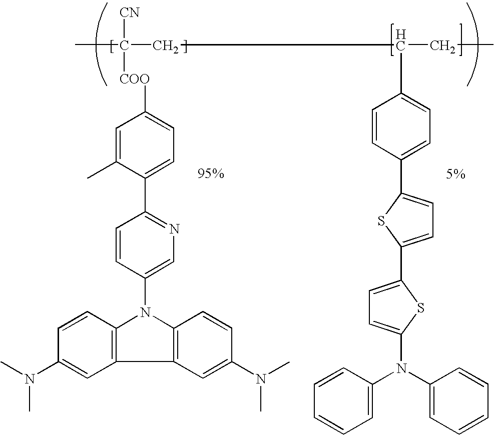

P-8

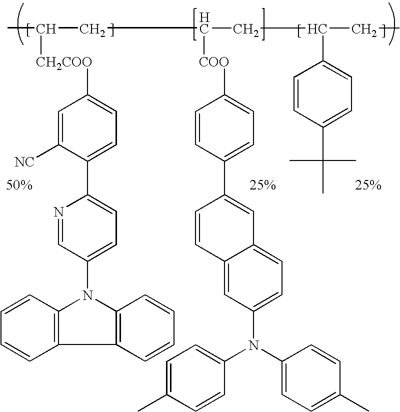

P-9

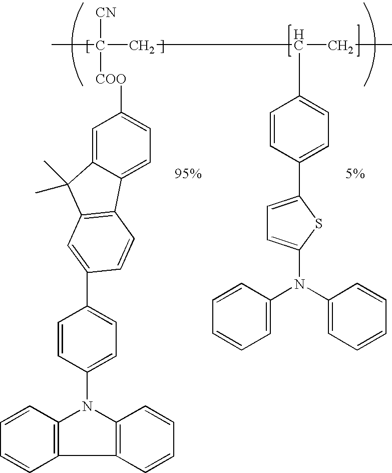

P-10

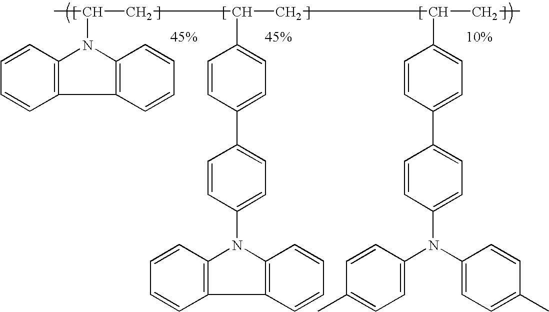

P-11

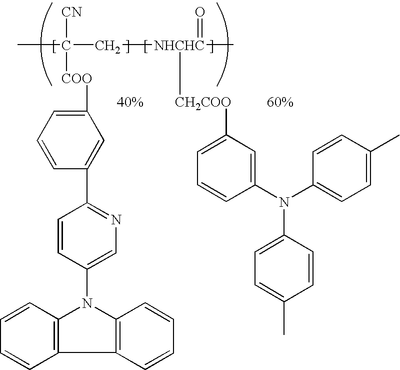

P-12

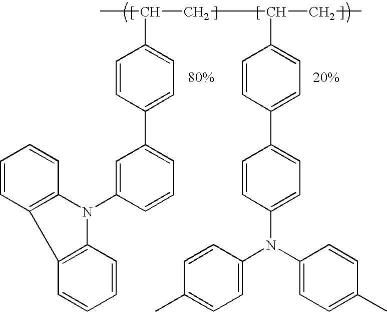

P-13

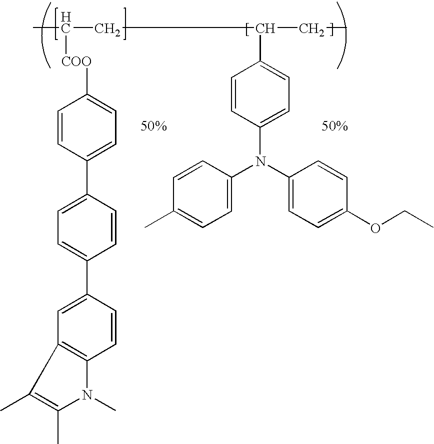

P-14

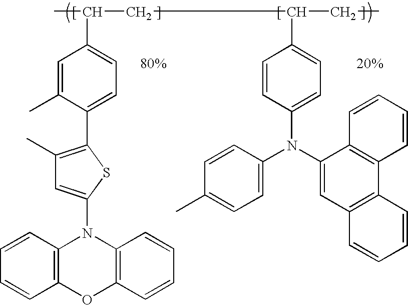

P-15

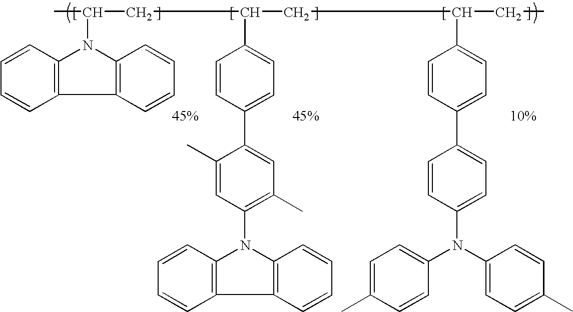

P-16

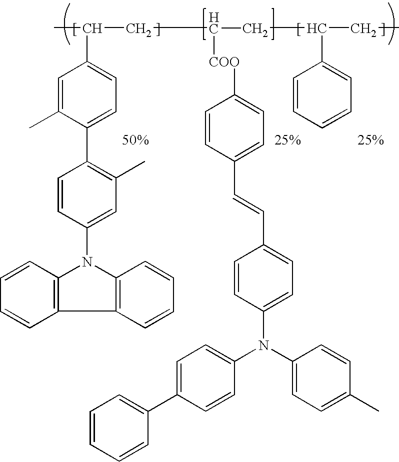

P-17

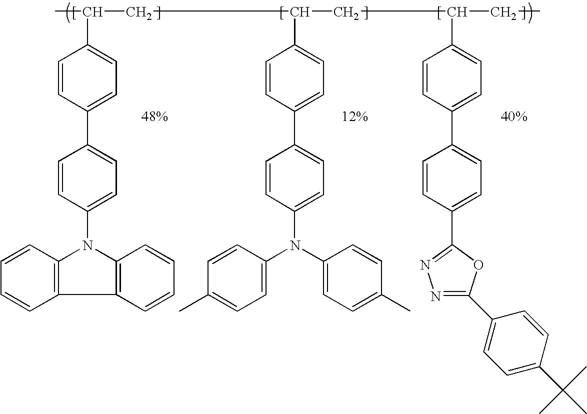

P-18

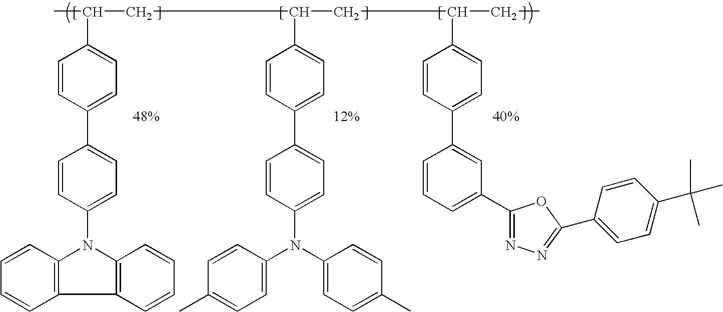

P-19

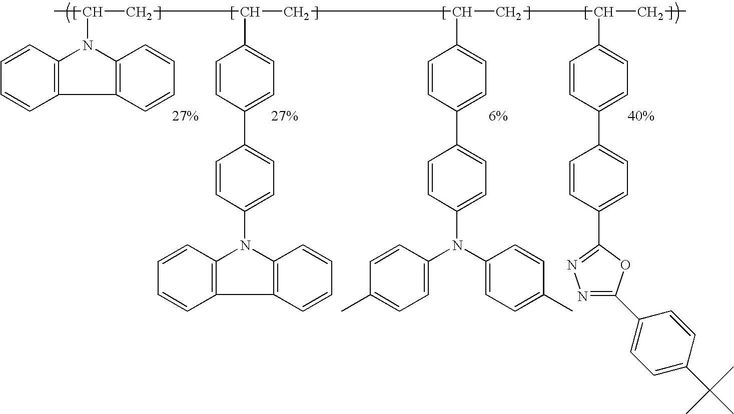

P-20

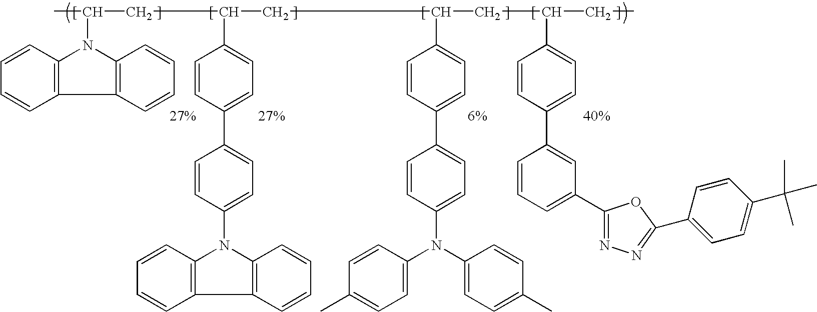

The copolymer having the unit represented by General Formula [1] and the amino group-containing unit of the present invention is superior in light-emitting and hole transporting properties. Further, the copolymer containing a unit derived from N-vinylcarbazole or the derivative thereof, styrene or the derivative thereof, acrylic acid or the derivative thereof, maleic acid or the derivative thereof, an organic acid vinyl ester, or the like as the copolymerization unit together with the aforementioned units has also similar characteristics. Thus, these copolymers can be used effectively as an emitting material with a hole transporting property in organic electroluminescent elements. The copolymers can also be, of course, used favorably as a hole transporting material in organic electroluminescent elements. The unit derived from styrene or the derivative thereof, acrylic acid or the derivative thereof, maleic acid or the derivative thereof, the organic acid vinyl ester, or the like used as the copolymerization unit is introduced for improvement in physical properties of the copolymer, for example a film-forming property, while the unit derived from N-vinylcarbazole or the derivative thereof is introduced for adjustment and improvement of the hole transporting property in addition to the improvement in physical properties. Further, a copolymer containing the unit represented by General Formula [7] additionally as the copolymerization unit has an electron transporting property. Therefore, the copolymer containing the unit represented by General Formula [7] can be used as any material of an emitting material, a hole transporting material, and an electron transporting material in organic electroluminescent elements. The copolymers according to the present invention may be used alone as the material for organic electroluminescent elements and may be also used in combination with another organic or inorganic material as the material for organic electroluminescent elements. The organic material used in combination with the copolymer according to the present invention may be a low-molecular weight organic material or a polymeric organic material. The copolymer may also be used as laminated with another polymeric organic material by coating. Further, combined or laminated use with a low-molecular weight compound is also possible. In such a case, the low-molecular weight compound may be coated as a mixture with a polymer binder or laminated, for example, by a method such as vacuum deposition or sputtering.

Hereinafter, the material for organic electroluminescent elements according to the present invention and the organic electroluminescent element using the same according to the present invention will be described specifically, but the material for organic electroluminescent elements and the organic electroluminescent element according to the present invention are not limited thereto.

The organic electroluminescent element is an element having a single- or multi-layered organic thin film between an anode and a cathode. In the case of the single-layered thin film type organic electroluminescent element, a light-emitting layer is closely formed between the anode and the cathode. The light-emitting layer contains an emitting material, and in addition, may contain a hole transporting material or an electron transporting material for transporting the holes injected from the anode or the electrons injected form the cathode to the emitting material. Examples of the multi-layered thin film elements include organic electroluminescent elements having a laminated multi-layer structure such as [anode/hole injection region/light-emitting layer/cathode], [anode/light-emitting layer/electron injection region/cathode], or [anode/hole injection region/light-emitting layer/electron injection region/cathode]. In addition, there is known to form auxiliary layer(s) between the layers for improvement in the pressure resistance of the luminescent element or the adhesiveness between the layers. The organic electroluminescent element according to the present invention may have any one of these conventionally known layer structures. The organic electroluminescent elements having these layers are normally prepared in the following manner. That is, first, an anode layer is formed on a transparent substrate, a hole injection region is formed as needed on the anode layer, and a light-emitting layer is formed on the hole injection region. Further, an electron injection region is formed as needed on the light-emitting layer and a cathode layer is formed thereon. Then, the anode and cathode layers are connected to a direct current power source. In addition, the anode layer was first formed on the substrate in the examples above, but the cathode layer may be formed first on the substrate. Further, each of the hole injection region, the light-emitting layer, and the electron injection region may be formed as a layer structure of two or more layers. In that case, in the hole injection region, the layer into which holes are injected from the electrode is called hole injection layer, and the layer which receives the holes from the hole injection layer and transports the holes to the light-emitting layer is called hole transporting layer. Similarly in the electron injection region, the layer into which electrons are injected from the electrode is called electron injection layer, and the layer which receives the electrons from the electron injection layer and transports the electrons to the light-emitting layer is called electron transporting layer. These layers are selected and used suitably according to the energy level, heat resistance property, adhesiveness to the organic layer or metal electrodes, and others of the material.

The transparent substrate favorably used is a glass plate, a transparent resin substrate, a quartz glass plate, or the like. The conductive substance used as the anode material of the organic electroluminescent element preferably has a work function of more than 4 eV, and examples thereof include carbon, metals such as aluminum, vanadium, iron, cobalt, nickel, tungsten, silver, gold, platinum, and palladium, and the alloys thereof; metal oxides used in ITO and NESA substrates such as tin oxide and indium oxide; and organic conductive resins such as polythiophene and polypyrrole. In addition, the conductive substance used as the cathode material preferably has a work function of less than 4.0 eV, and examples thereof include metals such as magnesium, barium, calcium, cesium, aluminum, tin, lead, titanium, yttrium, lithium, ruthenium, and manganese and the alloy thereof; but the conductive substances used for forming the anode and cathode are not limited thereto. The anode and the cathode may have a layer structure of two or more layers if needed.

As described above, the copolymer for the material for organic electroluminescent elements according to the present invention is superior in light-emitting and hole transporting properties. The copolymer having the unit represented by General Formula [7] of the present invention is also superior in an electron transporting property. Thus, the copolymer can be used as an emitting material a hole transporting material, and an electron transporting material. Therefore, it is used as a material for the light-emitting layer, the hole injection region, and the electron injection region, and particularly used favorably as a material for the light-emitting layer.

The copolymer according to the present invention may be used alone or as a mixture with another emitting material or another hole or electron transporting compound in the same layer. Such another emitting materials include those emitting the light based on the singlet exciton, based on the triplet exciton and based on the both excitons, and any one of these emitting materials can be used as the material for organic electroluminescent elements according to the present invention. Examples of the emitting or dopant materials capable of being used in combination with the copolymer according to the present invention in the light-emitting layer include polyalkylfluorene derivatives, polyphenylene derivatives, polyphenylene vinylene derivatives, polythiophene derivatives, and other light-emitting polymers. Examples of the emitting or dopant materials also included, but are not limited to, anthracene, naphthalene, phenanthrene, pyrene, tetracene, coronene, chrysene, fluorescein, perylene, phthaloperylene, naphthaloperylene, perynone, phthaloperynone, naphthaloperynone, diphenylbutadiene, tetraphenylbutadiene, coumarin, oxadiazole, aldazine, bisbenzoxazoline, bisstyryl, pyrazine, cyclopentadiene, quinoline metal complexes, aminoquinoline metal complexes, benzoquinoline metal complexes, imines, diphenylethylene, vinylanthracene, diaminocarbazole, pyran, thiopyran, polymethine, merocyanine, imidazole-chelated oxynoid compounds, quinacridone, rubrene, fluorescent colorants for colorant laser and sensitization, and the like.

The emitting or dopant material capable of being used in combination with the copolymer according to the present invention in the light-emitting layer is particularly preferably an emitting material capable of emitting light based on the triplet exciton. The emitting materials capable of emitting light based on the triplet exciton includes triplet light-emitting metal complexes, and as examples thereof, are known an iridium complex, Ir(ppy)₃ (tris-ortho-metalated complex of iridium (III) with 2-phenylpyridine) etc. A green luminescent element using Ir(ppy)₃ has an external quantum yield of 8%, higher than the external quantum yield of 5%, which was regarded as the maximum value of the conventional organic electroluminescent elements [see Applied Physics Letters 75, 4 (1999)]. In addition, Ir-complex compounds and metal-coordinated porphyrin compounds can be also used together with the copolymer according to the present invention, but the emitting or dopant material capable of being used in combination with the copolymer according to the present invention is not limited thereto.

The light-emitting layer may contain a hole transporting material or an electron transporting material additionally if needed. In an organic electroluminescent element, the deterioration in brightness and the shortening of lifetime by quenching can be prevented by a multilayered structure. If needed, an emitting material, a dopant material, a hole transporting material, and an electron transporting material may be used in combination. The dopant material allows improvement in luminescence brightness and luminous efficiency, and gives a red or blue luminescence.

The hole transporting material used together with the copolymer according to the present invention in the light-emitting layer or used in forming a hole transporting layer may be any one as long as it is a compound having an ability to transport the holes, having a superior hole injection effect from the anode, having a superior hole injection effect to the light-emitting layer or the emitting material, preventing migration of the excitons generated in the light-emitting layer to the electron injection region or the electron transporting material, and having a superior thin film-forming ability. Typical examples thereof include PEDOT (trade name: manufactured by Bayer, complex of poly(3,4-ethylenedioxy)-2,5-thiopheneandpolystyrenesulfonic acid), phthalocyaninederivatives, naphthalocyanine derivatives, porphyrin derivatives, oxazole, oxadiazole, triazole, imidazole, imidazolone, imidazolethione, pyrazoline, pyrazolone, tetrahydroimidazole, hydrazone, acylhydrazone, polyarylalkane, stilbene, butadiene, benzidine-type triphenylamines, styrylamine-type triphenylamines, diamine-type triphenylamines, and the derivatives thereof; polymeric materials such as polyvinylcarbazole, polysilane, and conductive polymers; and the like. However, the hole transporting material used in the organic electroluminescent element according to the present invention is not limited thereto.

The electron transporting material used together with the copolymer according to the present invention in the light-emitting layer or used in forming an electron transporting layer may be any compound as long as it is a compound having an ability to transport electrons, having a superior hole injection effect from the cathode, having a superior electron injection effect to the light-emitting layer or emitting material, preventing migration of the excitons generated in the light-emitting layer to the hole injection region, and having an superior thin film-forming ability. Typical examples of the electron transporting materials used in the organic electroluminescent element according to the present invention include, but are not limited to, fluorenone, anthraquinodimethane, diphenoquinone, thiopyranedioxide, oxazole, oxadiazole, triazole, imidazole, perylene tetracarboxylic acids, fluorenylidenemethane, anthraquinodimethane, anthrone, and the derivatives thereof. It is also possible to sensitize the hole transporting material by addition of an electron-accepting substance, and sensitize the electron transporting material by addition of an electron-donating substance.

The copolymer according to the present invention has a higher glass transition point and a higher melting point, and thus, is more resistant (heat resistant) to the Joule heat generated in an organic layer, between organic layers, or between an organic layer and an metal electrode during electroluminescence. The polymer shows a high luminescence brightness when used as an organic electroluminescent element material and is advantageous for emission over an extended period of time.

The method of forming a film of the material for organic electroluminescent elements according to the present invention is not particularly limited, and examples thereof include vacuum deposition from the powdery state, coating after dissolution thereof in a solvent (e.g., by inkjet ejection, spraying, printing, spin coating, casting, dipping, bar coating, roll coating, etc.), and the like. However, the coating method is preferable from the viewpoints of the simplicity of element production process, productivity and expansion of the device area. Examples of the solvents used when the film is formed by coating include organic halogenated solvents such as dichloroethane, dichloromethane, and chloroform; ether solvents such as tetrahydrofuran and 1,4-dioxane; aromatic hydrocarbon solvents such as toluene and xylene; amide solvents such as dimethylformamide and dimethylacetamide; ester solvents such as ethyl acetate and butyl acetate; and the mixed solvent thereof. The film is formed by using a solution containing a polymer usually at a concentration of 0.01 to 10 wt %, preferably 0.1 to 5 wt %, although the concentration may vary according to the structure and the molecular weight of the polymer. The thicknesses of the hole injection region, the light-emitting layer, and the electron injection region are not particularly limited, but are normally in the range of 1 to 1,000 nm respectively.

The organic electroluminescent element using the material for organic electroluminescent elements according to the present invention is applicable as flat panel displays for the wall-hung television set and others; plane illuminators; light sources for copying machines, printers, and others; light sources for liquid crystal displays, instruments, and others; display plate; illumination sings; marks; and others, and thus, significantly valuable industrially.

### BRIEF DESCRIPTION OF THE DRAWINGS

FIG. 1 is the infrared absorption spectrum of compound 1.

FIG. 2 is the ¹H-NMR spectrum of compound 1.

FIG. 3 is the infrared absorption spectrum of compound 2.

FIG. 4 is the ¹H-NMR spectrum of compound 2.

FIG. 5 is the infrared absorption spectrum of compound 3.

FIG. 6 is the ¹H-NMR spectrum of compound 3.

FIG. 7 is the infrared absorption spectrum of copolymer P-1.

FIG. 8 is the infrared absorption spectrum of copolymer P-10.

FIG. 9 is the infrared absorption spectrum of compound 5.

FIG. 10 is the ¹H-NMR spectrum of compound 5.

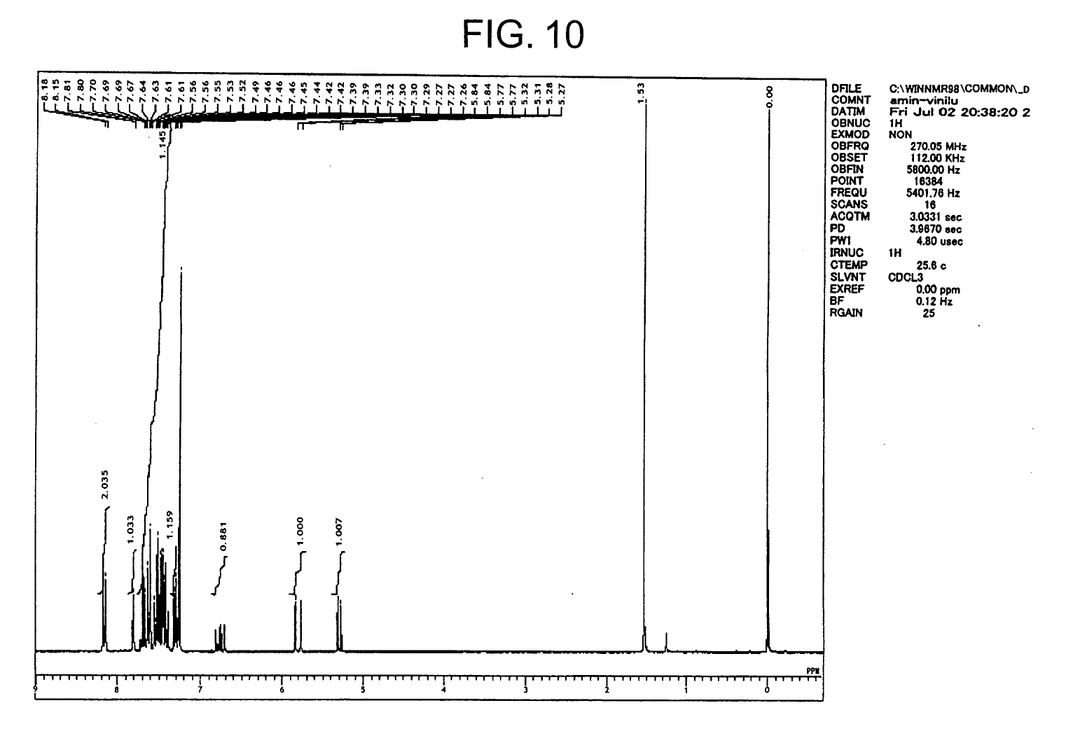

FIG. 11 is the infrared absorption spectrum of copolymer P-12.

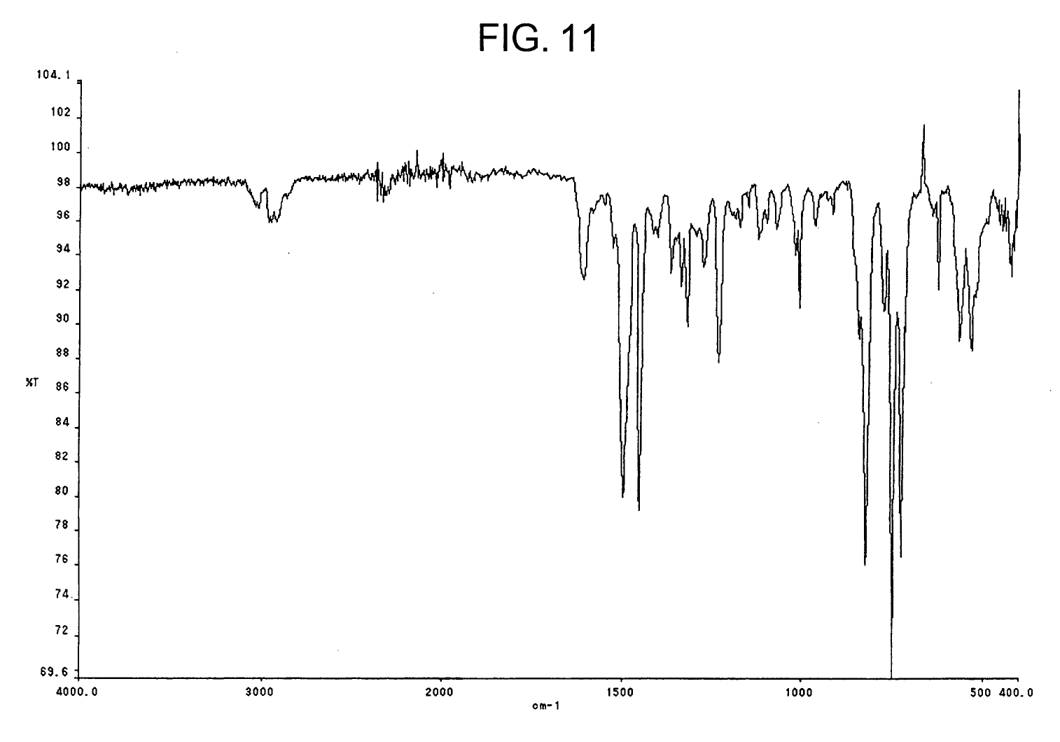

FIG. 12 is the infrared absorption spectrum of copolymer P-15.

FIG. 13 is the infrared absorption spectrum of compound 7.

FIG. 14 is the ¹H-NMR spectrum of compound 7.

FIG. 15 is the infrared absorption spectrum of copolymer P-17.

FIG. 16 is the infrared absorption spectrum of compound 8.

FIG. 17 is the ¹H-NMR spectrum of compound 8.

FIG. 18 is the infrared absorption spectrum of copolymer P-20.

### BEST MODE FOR CARRYING OUT THE INVENTION

Hereinafter, the material for organic electroluminescent elements according to the present invention and the organic electroluminescent element using the same will be described specifically with reference to Preparative Examples, Examples, and others, but it should be understood that the present invention is not limited thereto.

“Part” and “%” in the following Preparative Examples, Examples, and Comparative Examples mean “part by weight” and “wt %” respectively.

The infrared absorption spectra (IR) in the following Preparative Examples were determined by using Spectrum One Ver. A, which is Fourier-transform infrared spectrophotometer manufactured by Perkin Elmer, Inc. Alternatively the NMR spectra were determined by using GSX270, which is FT-NMR analyzer manufactured by JEOL. The GPC analysis was performed by using GPC-8020 (column: TSK gel Multipore H) manufactured by Toso Corporation.

### PREPARATIVE EXAMPLE 1

### Preparation of Copolymer P-1

A copolymer P-1 was prepared according to the following reaction scheme.

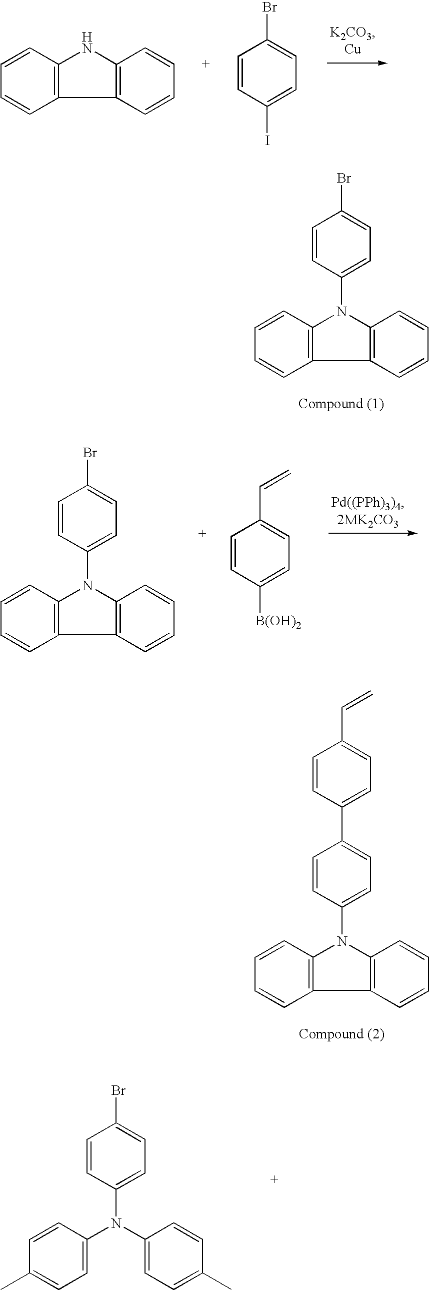

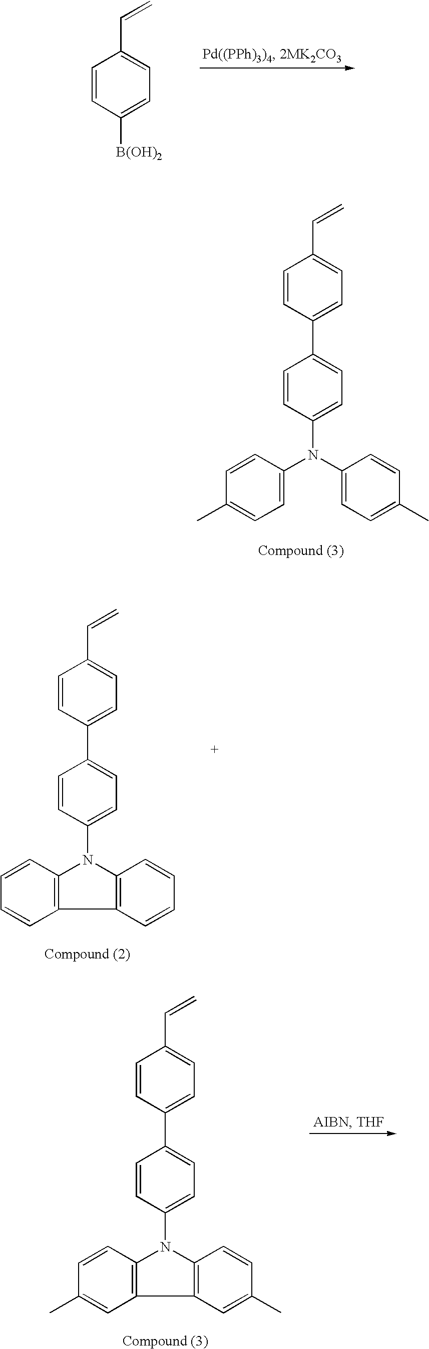

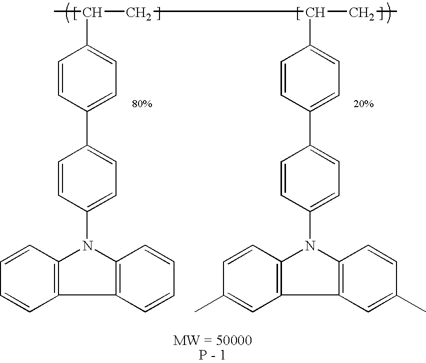

### <Preparation of Compound (1)>

Under dry nitrogen stream, 15.4 g (54.4 mmol) of p-bromoiodobenzene, 10.0 g (59.8 mmol) of carbazole, 0.3 g of Cu powder, 7.9 g (57.0 mmol) of K₂CO₃, and 100 ml of a solvent 1,3-dimethyl-2-imidazolidinone were mixed and stirred at 190° C. for 18 hours. The reaction solution was poured into 700 ml of water, and the precipitate was filtered and dried at 70° C., to give a crude product. The crude product was separated and purified by silica gel column chromatography, to give a purified compound (1). The yield was 55%.

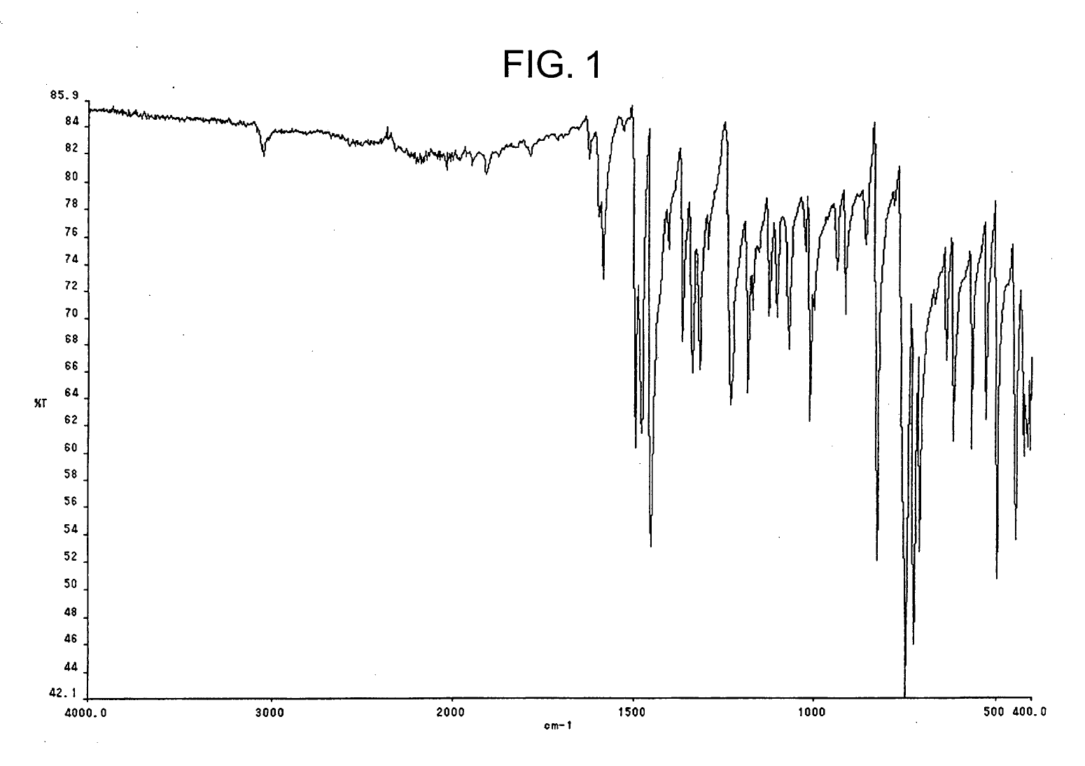

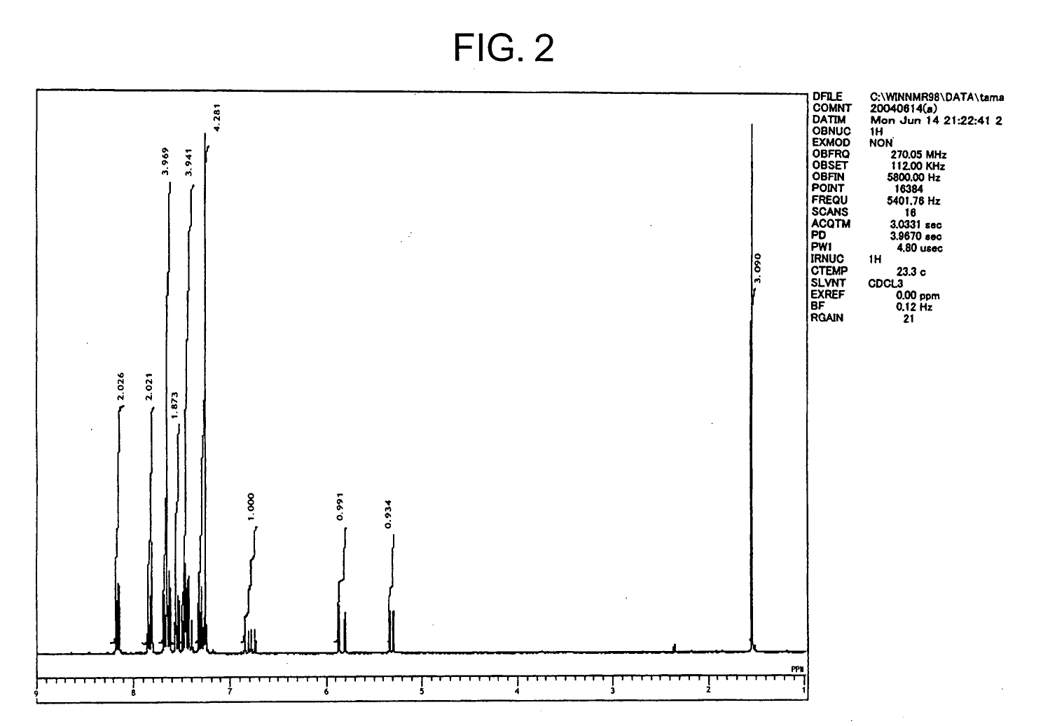

The structure of the compound (1) was determined by elemental analysis, mass spectrometry, infrared absorption spectrum, NMR spectrum, and others. The infrared absorption spectrum and ¹H-NMR spectrum of the compound (1) are shown respectively in FIGS. 1 and 2.

### <Preparation of Compound 2>

In a four-necked flask equipped with a condenser tube, 2.5 g (7.8 mmol) of the compound (1), 1.72 g (11.6 mmol) of 4-vinylphenylboronic acid, and 30 ml of tetrahydrofuran (THF) were placed, and the mixture was stirred. And then 30 ml of 2M K₂CO₃aq was added thereto. Further, 200 mg (174 mol) of tetrakistriphenylphosphine palladium(0) (Pd(PPh₃)) and 10 ml of THF were added thereto, and the mixture was heated under reflux at 80° C. for 24 hours. Purification by column chromatography and methanol reprecipitation gave a compound (2). The yield was 62%.

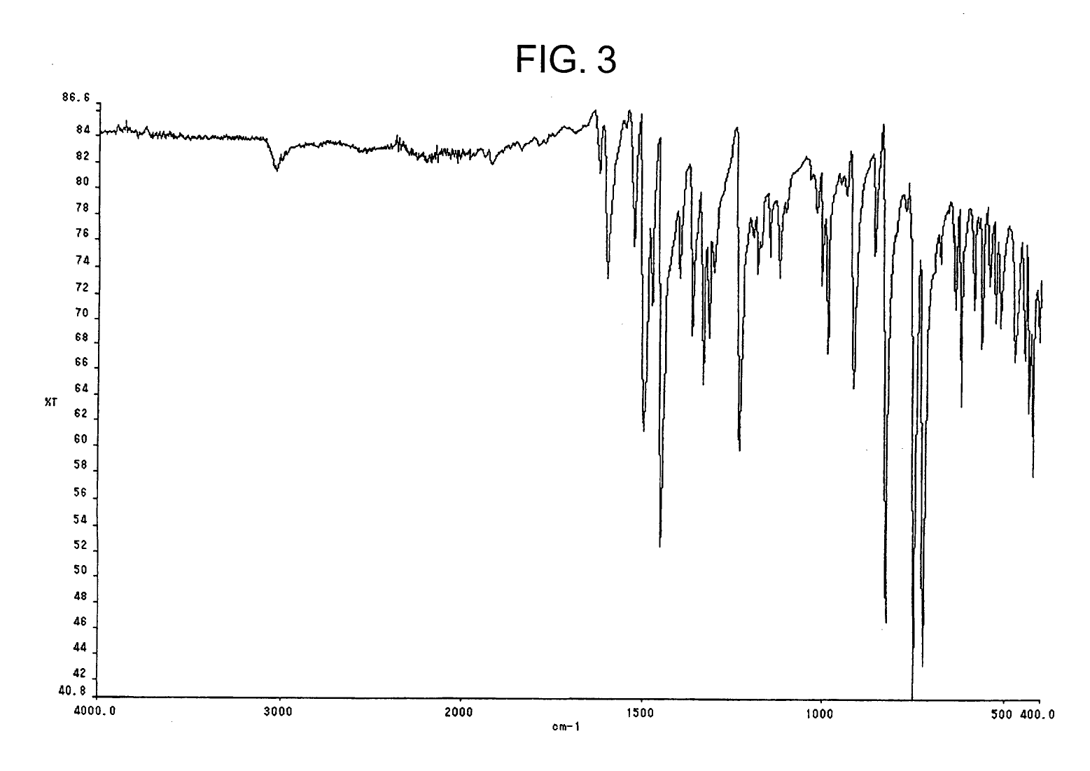

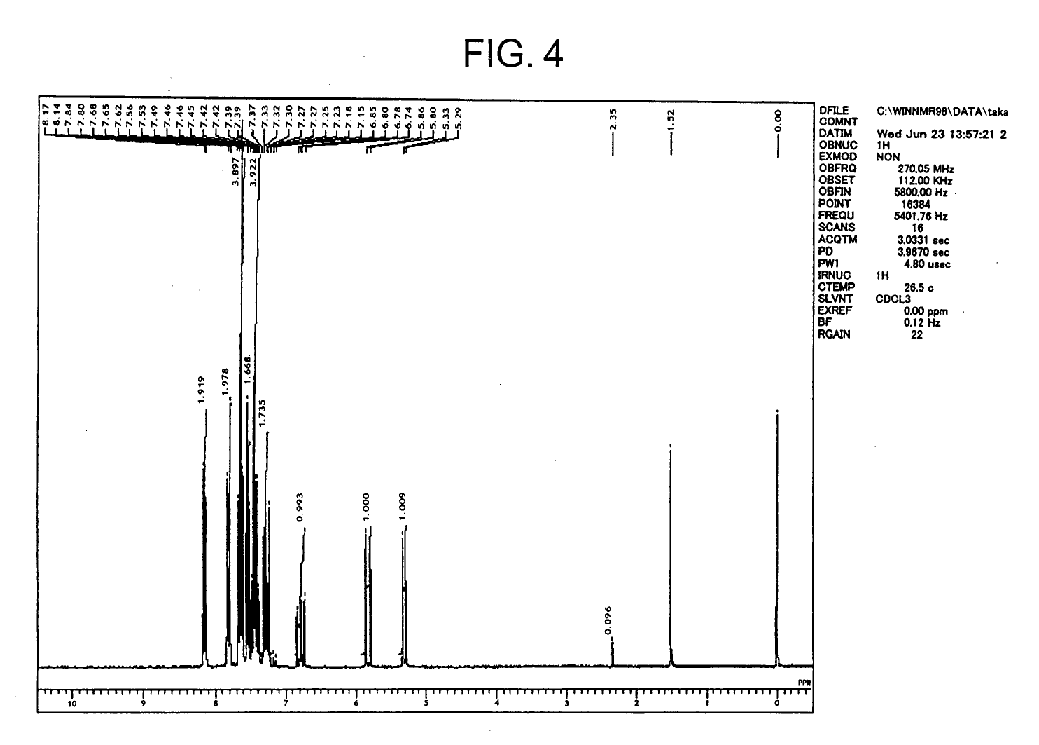

The structure of the compound (2) was determined by elemental analysis, mass spectrometry, infrared absorption spectrum, NMR spectrum, and others. The infrared absorption spectrum and ¹H-NMR spectrum of the compound (2) are shown respectively in FIGS. 3 and 4.

### <Preparation of Compound 3>

In a four-necked flask equipped with a condenser tube, 6.79 g (19.27 mmol) of 4-bromo-N,N-ditolrylamine, 3.0 g (20.27 mmol) of 4-vinylphenylboronic acid, and 50 ml of THF were placed, and the mixture was stirred. And then 50 ml of 2M K₂CO₃aq was added thereto. Further, 351 mg (304 mol) of tetrakistriphenylphosphine palladium(0) (Pd(PPh₃)) and 10 ml of THF were added thereto, and the mixture was heated under reflux at 80° C. for 24 hours. Purification by column chromatography and methanol reprecipitation gave a compound (3). The yield was 65%.

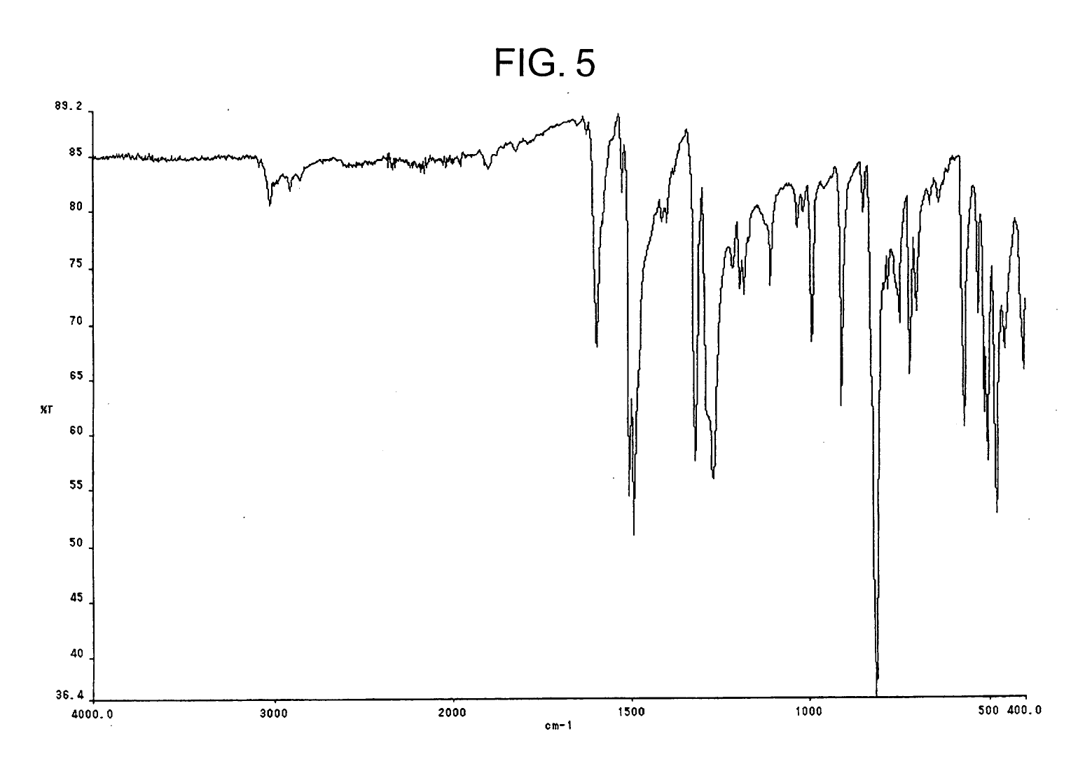

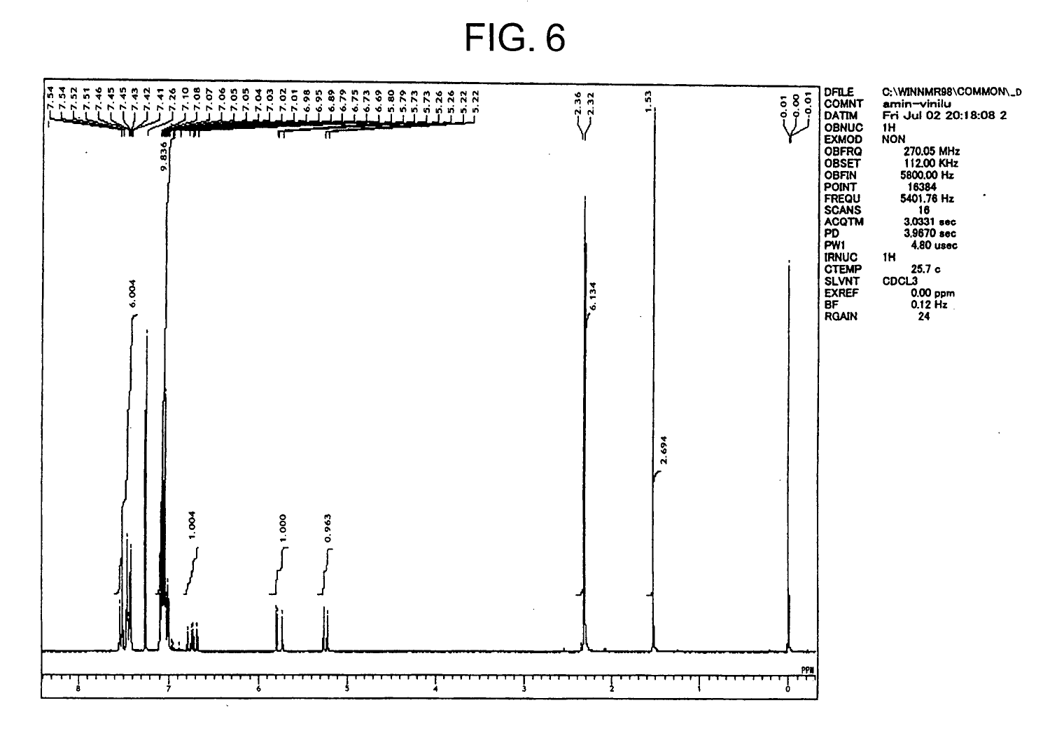

The structure of the compound (3) was determined by elemental analysis, mass spectrometry, infrared absorption spectrum, NMR spectrum, and others. The infrared absorption spectrum and ¹H-NMR spectrum of the compound (3) are shown respectively in FIGS. 5 and 6.

### <Preparation of Copolymer P-1>

The compounds (2) and (3) were placed in a Shrenk flask in amounts of respectively 0.8 g and 0.2 g, and the flask was deaerated under vacuum several times. 0.02 g of azobis(isobutylonitrile) and 2.7 ml of THF were added thereto, and the mixture was stirred at 70° C. for 9 hours. The reaction solution obtained was viscous. The product was purified by methanol reprecipitation. The yield was 90%.

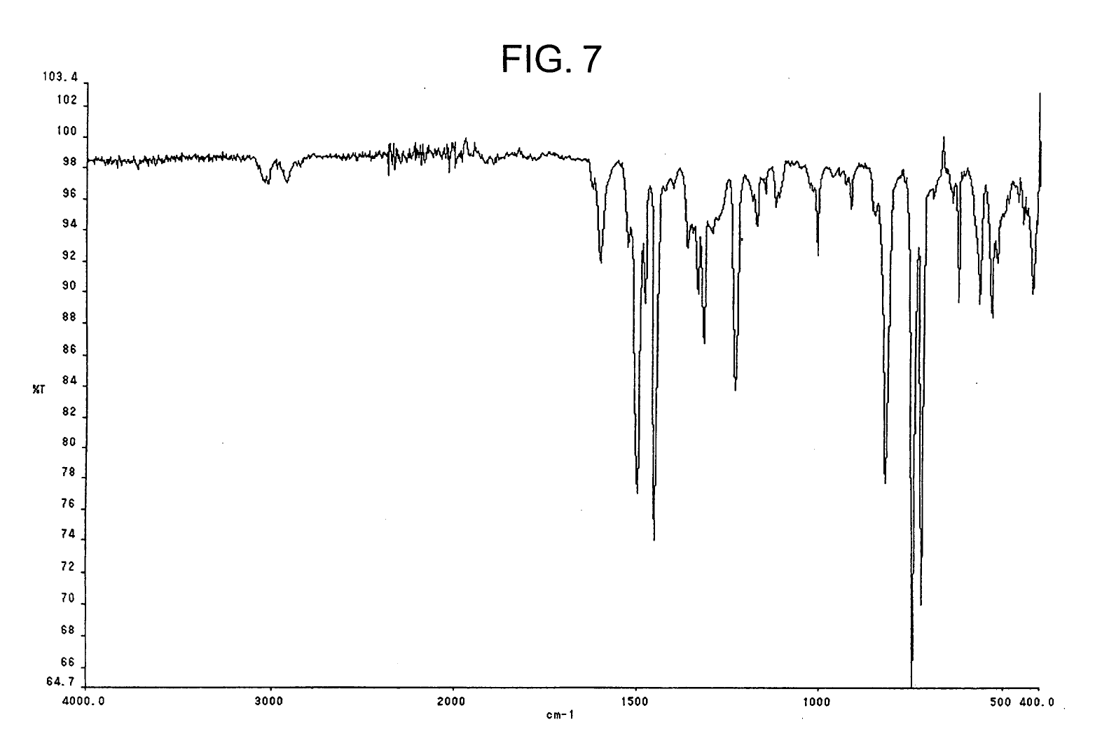

Elemental analysis, infrared absorption spectrum, NMR spectrum, and others of the white powder obtained showed that the product was a copolymer P-1 having the structure above (copolymerization ratio: 80:20). GPC analysis showed that the weight-average molecular weight (Mw) of the copolymer P-1 was 50,000. The infrared absorption spectrum of the copolymer P-1 is shown in FIG. 7.

### PREPARATIVE EXAMPLE 2

### Preparation of Copolymer P-10

The copolymer P-10 was prepared according to the following reaction formula.

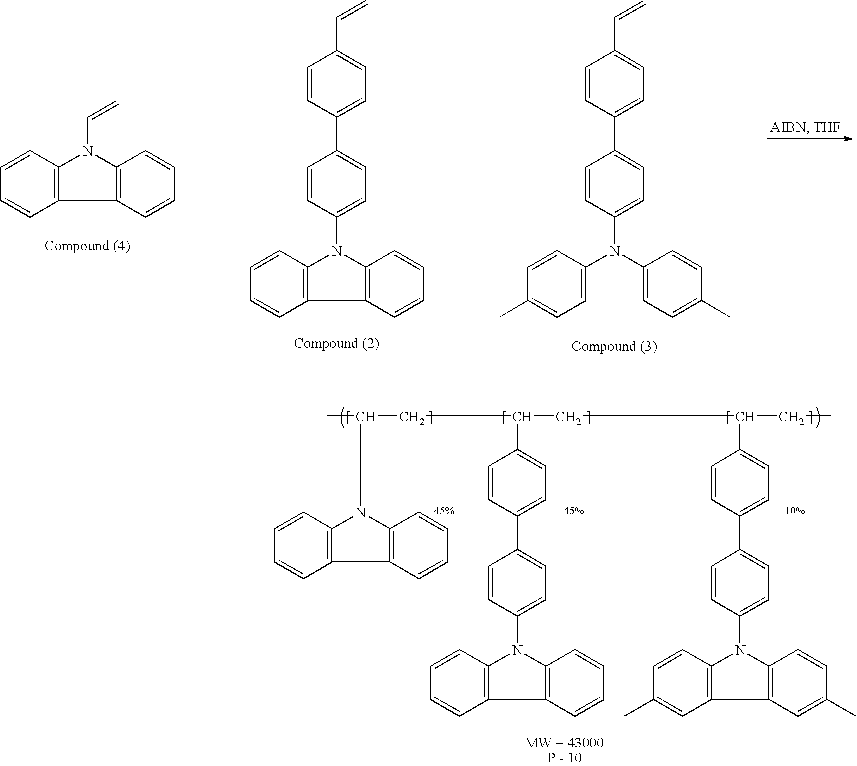

The compounds (4), (2) and (3) were placed in a Shrenk flask in amounts of respectively 0.34 g, 0.45 g, and 0.1 g, and the flask was deaerated under vacuum several times. 0.02 g of azobis(isobutylonitrile) and 2.7 ml of THF were added thereto, and the mixture was stirred at 70° C. for 9 hours. The reaction solution obtained was viscous. The product was purified by methanol reprecipitation. The yield was 90%.

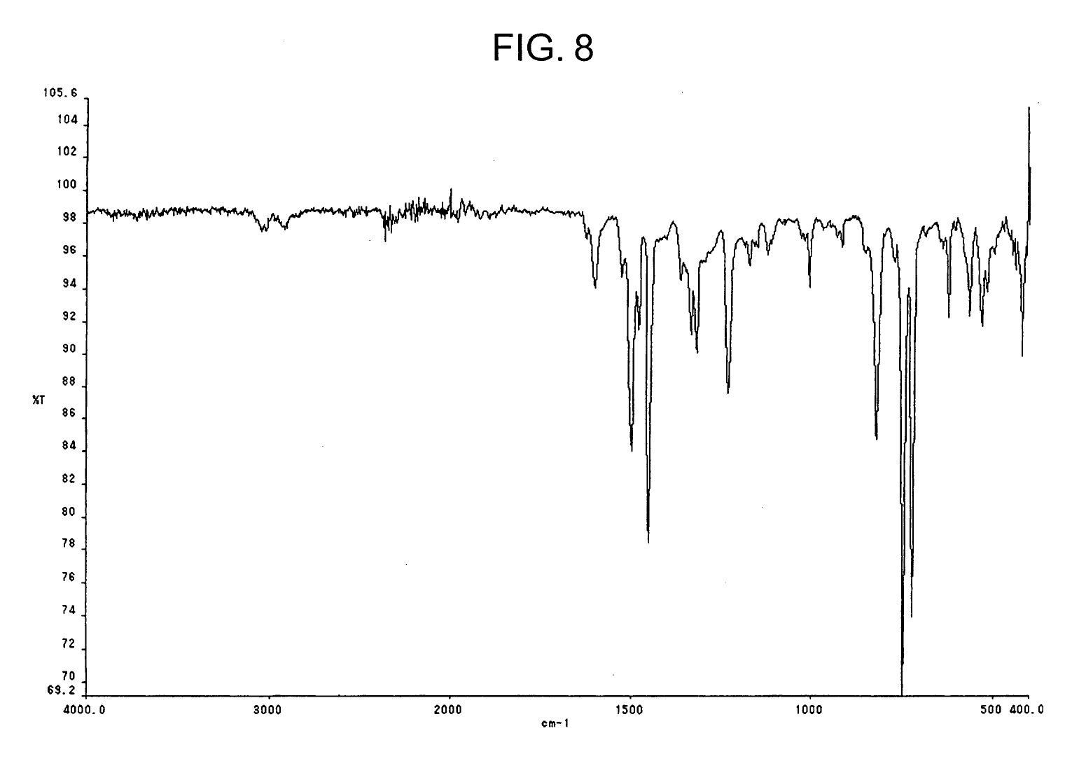

Elemental analysis, infrared absorption spectrum, NMR spectrum, and others of the white powder obtained showed that the product was a copolymer P-10 having the structure above (copolymerization ratio: 45:45:10). GPC analysis showed that the weight-average molecular weight (Mw) of the copolymer P-10 was 43,000. The infrared absorption spectrum of the copolymer P-10 is shown in FIG. 8.

### PREPARATIVE EXAMPLE 3

### Preparation of Copolymer P-12

The copolymer P-12 was prepared according to the following reaction formula.

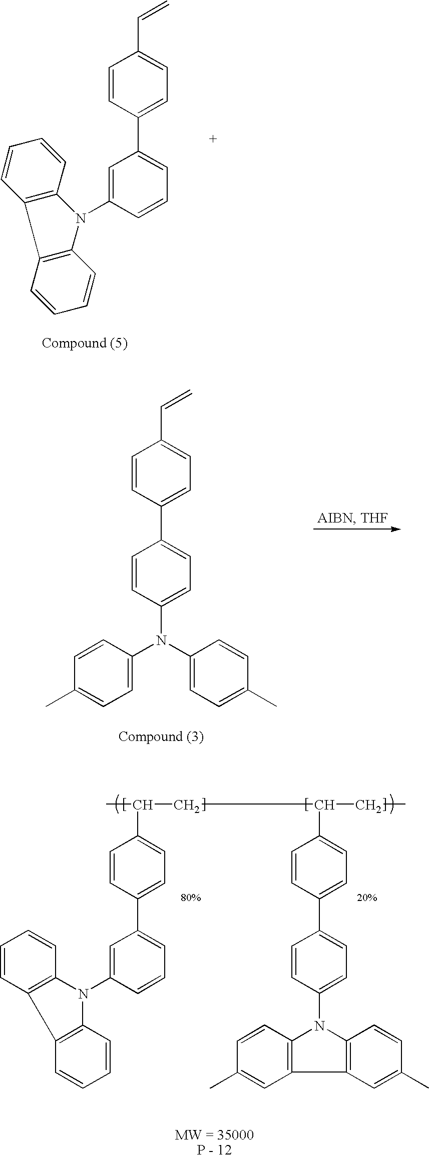

The compounds (5) and (3) were placed in a Shrenk flask in amounts of respectively 0.8 g and 0.2 g, and the flask was deaerated under vacuum several times. 0.02 g of azobis (isobutylonitrile) and 2.7 ml of THF were added thereto, and the mixture was stirred at 70° C. for 9 hours. The reaction solution obtained was viscous. The product was purified by methanol reprecipitation. The yield was 90%.

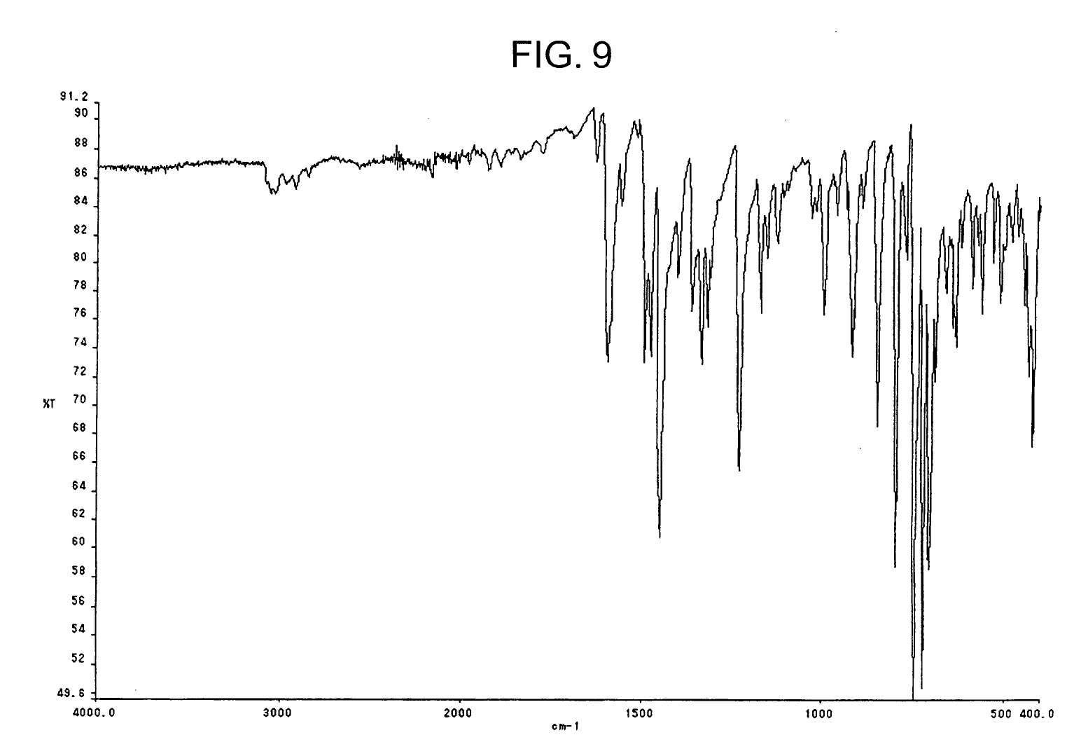

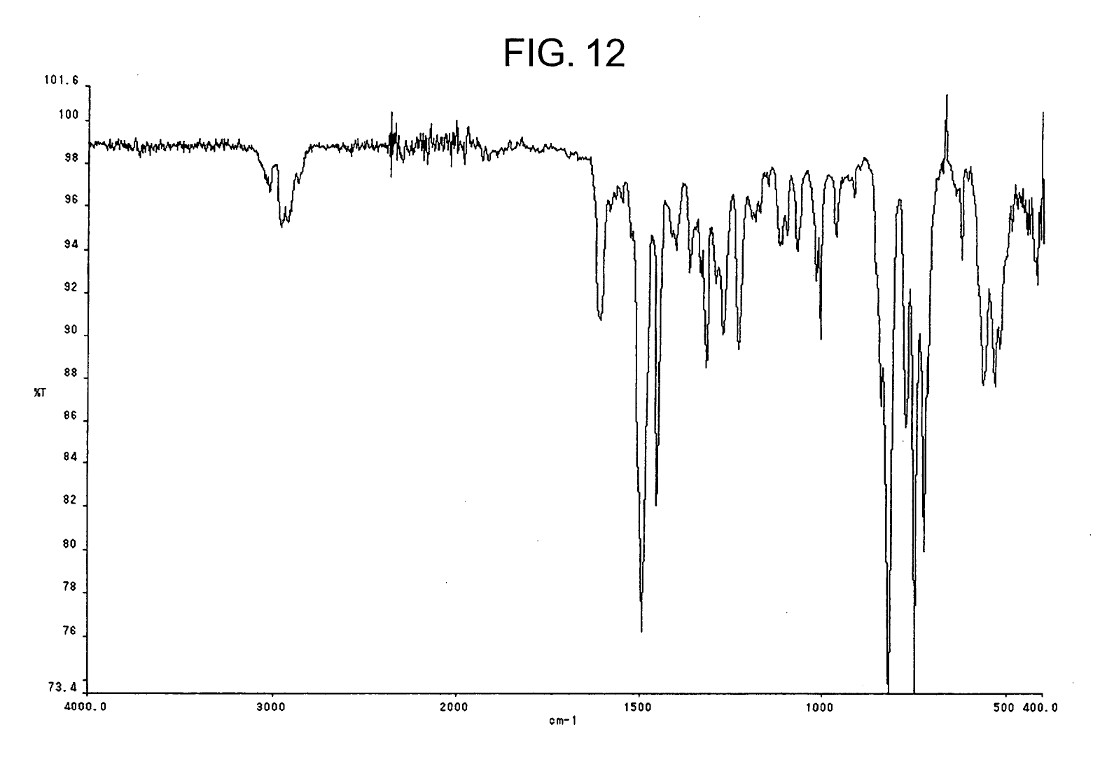

Elemental analysis, infrared absorption spectrum, NMR spectrum, and others of the white powder obtained showed that the product was a copolymer P-12 having the structure above (copolymerization ratio: 80:20). GPC analysis showed that the weight-average molecular weight (Mw) of the copolymer P-12 was 35,000. The infrared absorption spectrum and ¹H-NMR spectrum of the compound (5) are shown respectively in FIGS. 9 and 12.

### PREPARATIVE EXAMPLE 4

### Preparation of Copolymer P-15

The copolymer P-15 was prepared according to the following reaction formula.

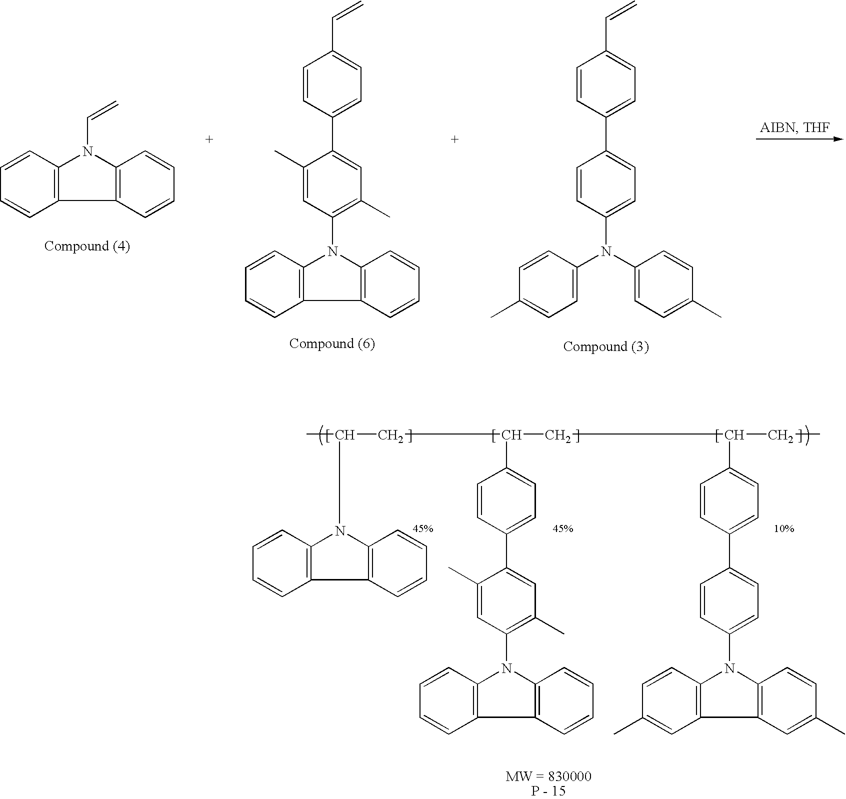

The compounds (4), (6) and (3) were placed in a Shrenk flask in amounts of respectively 0.45 g, 0.45 g, and 0.1 g, and the flask was deaerated under vacuum several times. 0.02 g of azobis(isobutylonitrile) and 2.7 ml of THF were added thereto, and the mixture was stirred at 70° C. for 9 hours. The reaction solution obtained was viscous. The product was purified by methanol reprecipitation. The yield was 90%.

Elemental analysis, infrared absorption spectrum, NMR spectrum, and others of the white powder obtained showed that the product was a copolymer P-15 having the structure above (copolymerization ratio: 45:45:10). GPC analysis showed that the weight-average molecular weight (Mw) of the copolymer P-15 was 83,000. The infrared absorption spectrum of the copolymer P-15 is shown in FIG. 12.

### PREPARATIVE EXAMPLE 5

### Preparation of Copolymer P-17

The copolymer P-17 was prepared according to the following reaction formula.

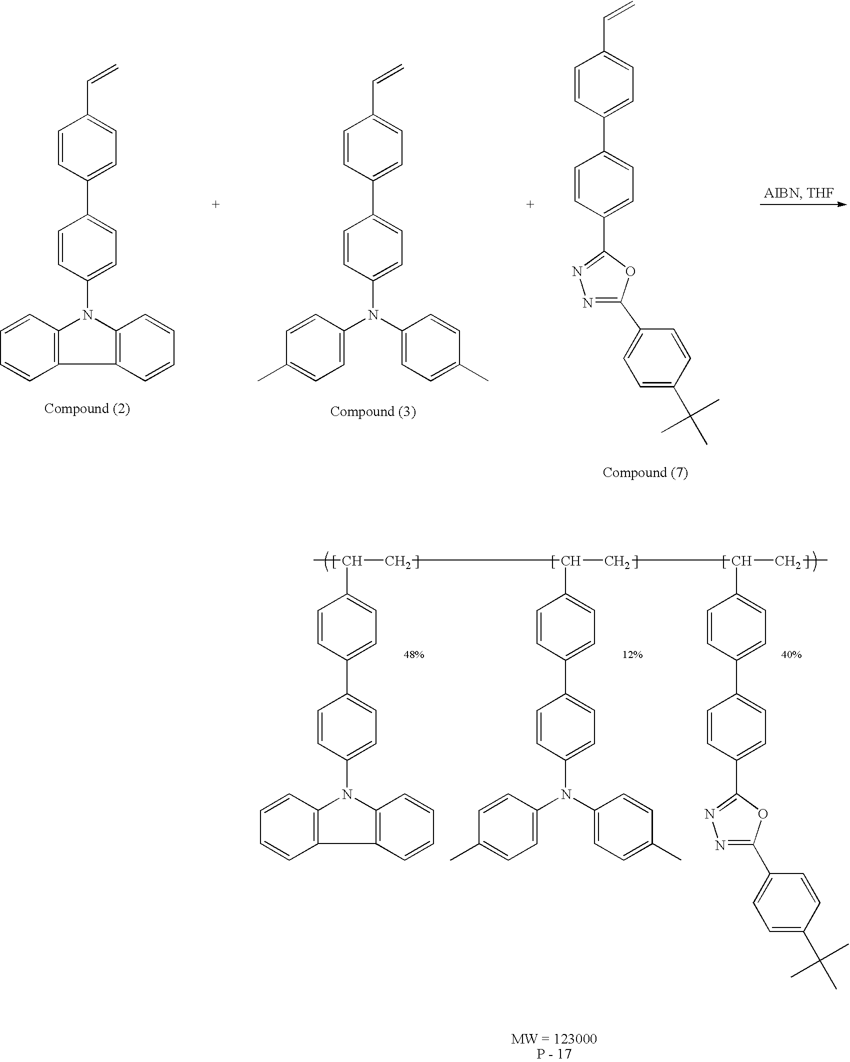

The compounds (2), (3) and (7) were placed in a Shrenk flask in amounts of respectively 0.48 g, 0.12 g, and 0.40 g, and the flask was deaerated under vacuum several times. 0.02 g of azobis(isobutylonitrile) and 2.7 ml of THF were added thereto, and the mixture was stirred at 70° C. for 9 hours. The reaction solution obtained was viscous. The product was purified by methanol reprecipitation. The yield was 90%.

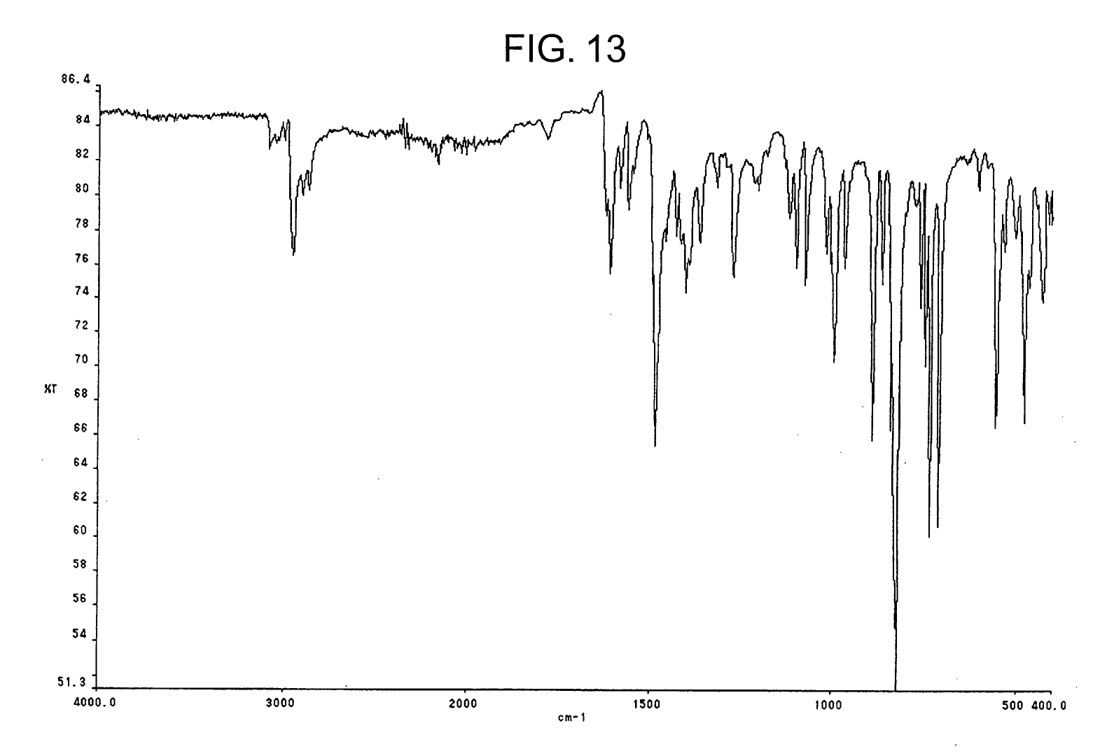

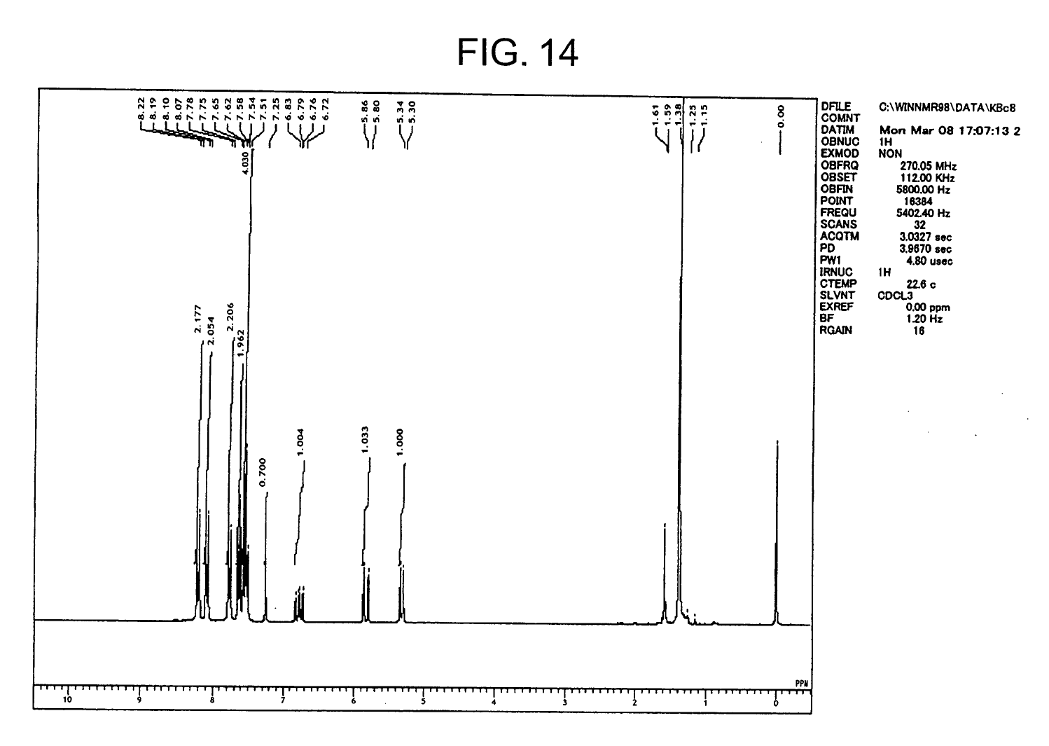

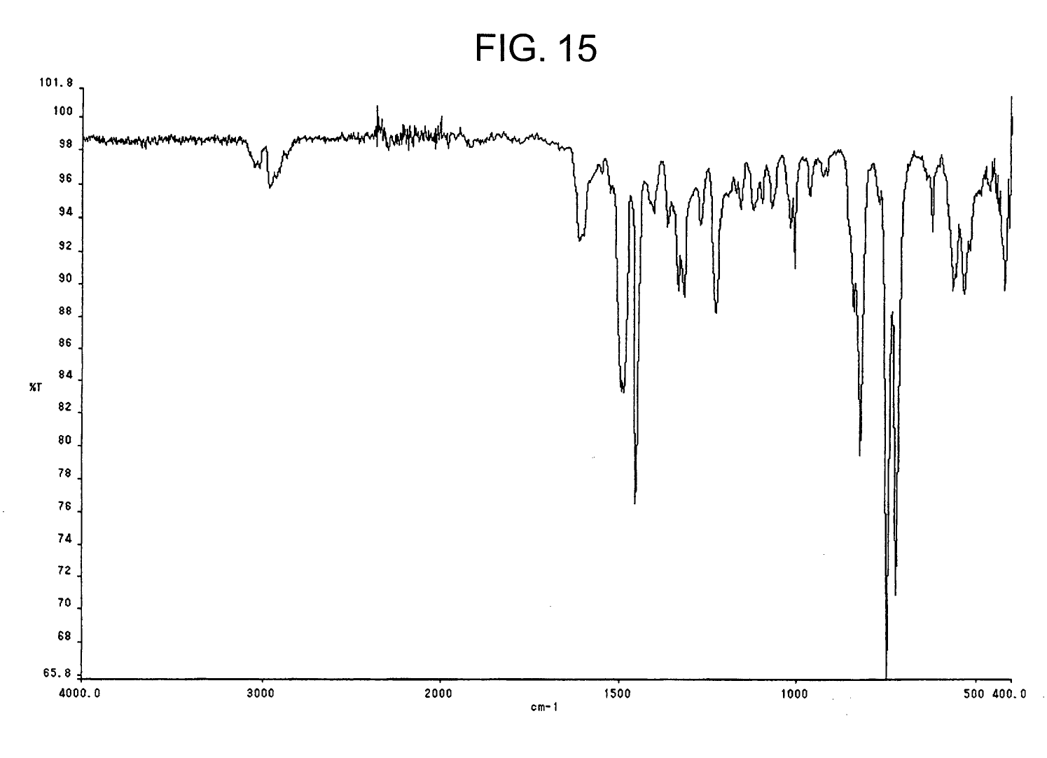

Elemental analysis, infrared absorption spectrum, NMR spectrum, and others of the white powder obtained showed that the product was a copolymer P-17 having the structure above (copolymerization ratio: 48:12:40). GPC analysis showed that the weight-average molecular weight (Mw) of the copolymer P-17 was 123,000. The infrared absorption spectrum and ¹H-NMR spectrum of the compound (7) are shown respectively in FIGS. 13 and 14, and the infrared absorption spectrum of the copolymer P-17 is shown in FIG. 15.

### PREPARATIVE EXAMPLE 6

### Preparation of Copolymer P-20

The copolymer P-20 was prepared according to the following reaction formula.

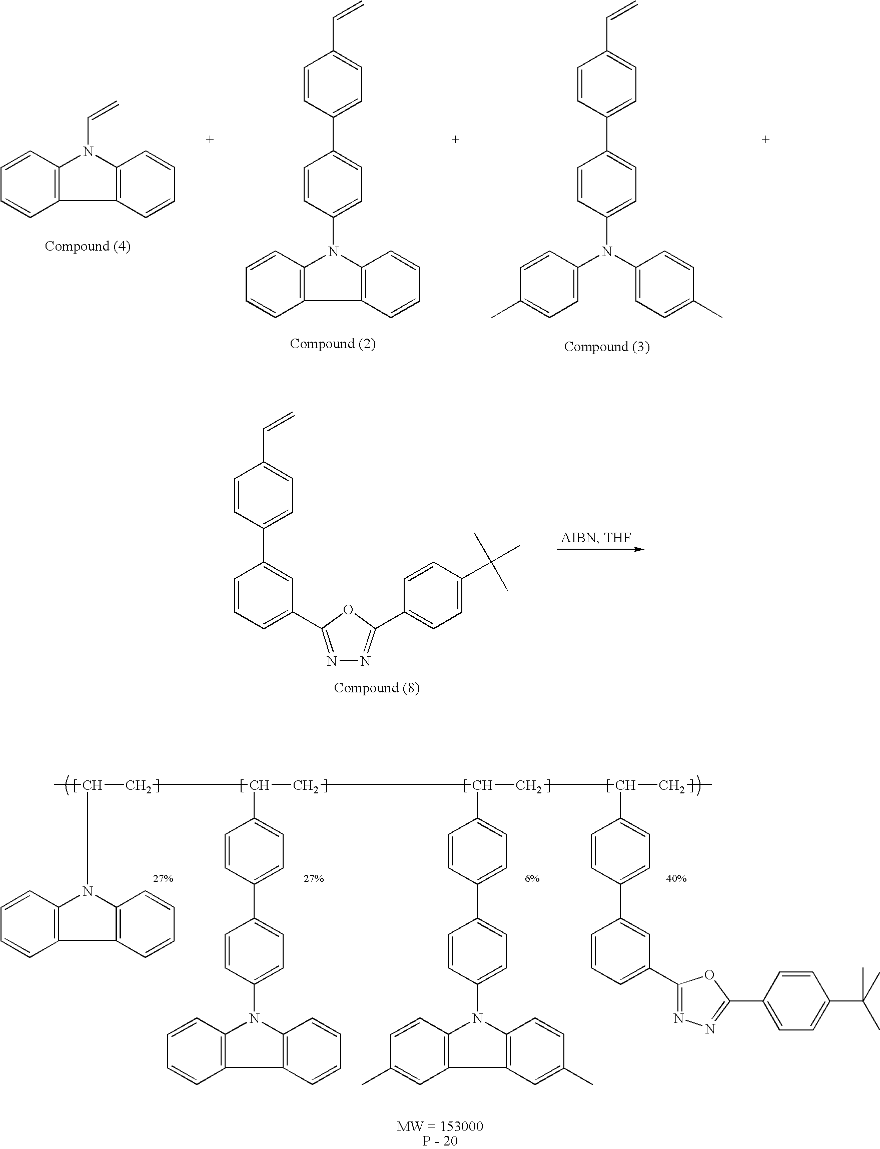

The compounds (4), (2), (3) and (8) were placed in a Shrenk flask in amounts of respectively 0.27 g, 0.27 g, 0.06 g, and 0.4 g, and the flask was deaerated under vacuum several times. 0.02 g of azobis (isobutylonitrile) and 2.7 ml of THF were added thereto, and the mixture was stirred at 70° C. for 9 hours. The reaction solution obtained was viscous. The product was purified by methanol reprecipitation. The yield was 95%.

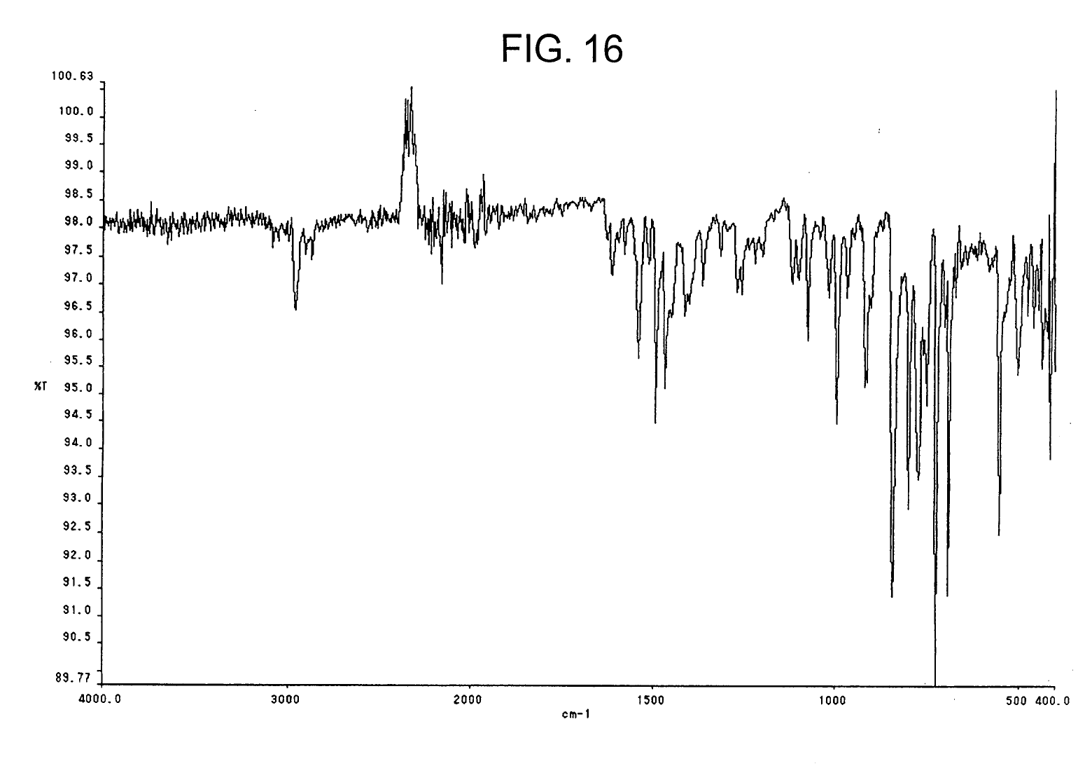

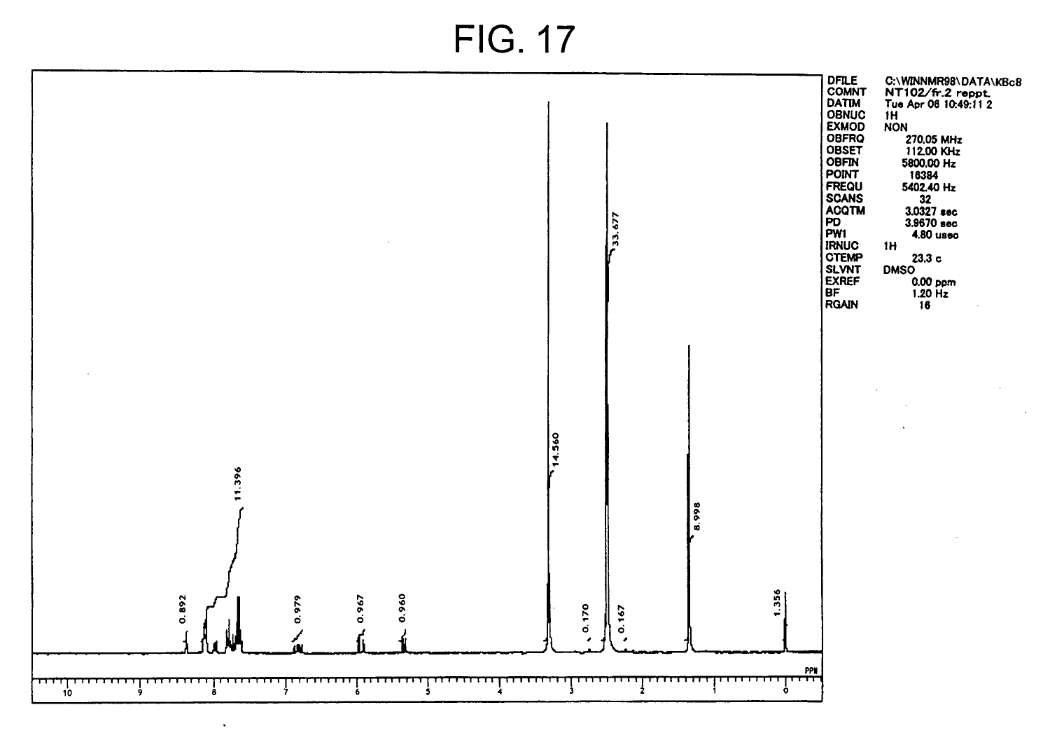

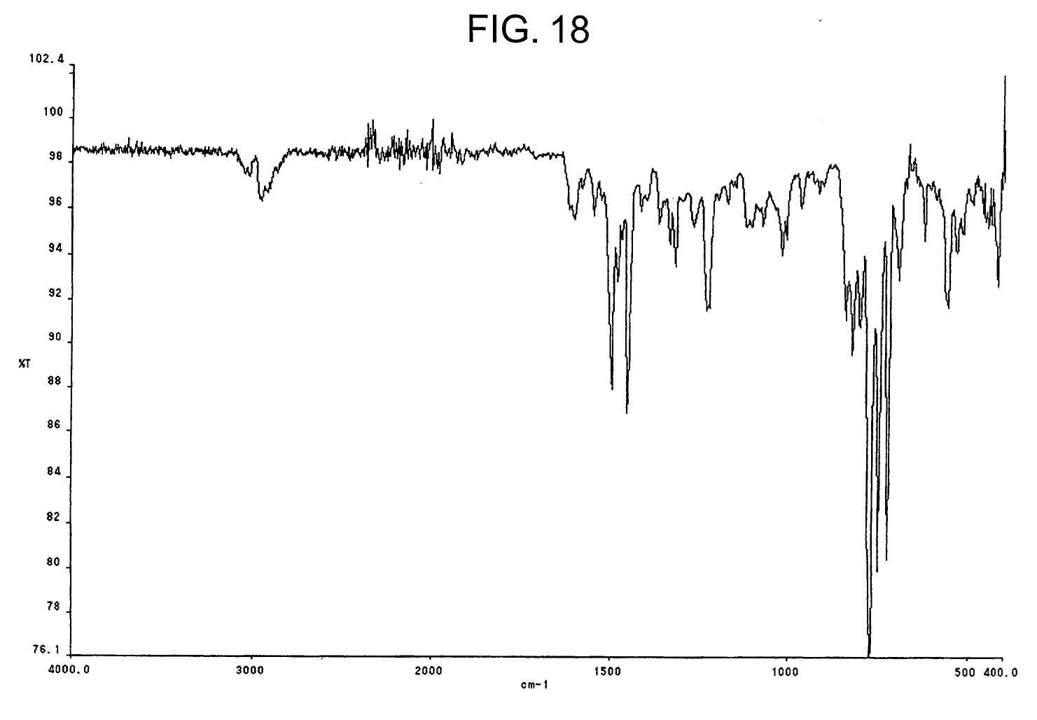

Elemental analysis, infrared absorption spectrum, NMR spectrum, and others of the white powder obtained showed that the product was a copolymer P-20 having the structure above (copolymerization ratio: 27:27:6:40). GPC analysis showed that the weight-average molecular weight (Mw) of the copolymer P-20 was 153,000. The infrared absorption spectrum and ¹H-NMR spectrum of the compound (8) are shown respectively in FIGS. 16 and 17, and the infrared absorption spectrum of the copolymer P-20 is shown in FIG. 18.

### EXAMPLE 1

On a glass plate having a cleaned ITO electrode, PEDOT/PSS [poly(3,4-ethylenedioxy)-2,5-thiophene/polystyrenesulfonic acid] was coated by spin coating into a film thickness of 40 nm, and a solution of the copolymer P-1 obtained in Preparative Example 1 and Ir(ppy)₃ (3%) dissolved in dichloroethane at a concentration of 1.0 wt % was coated thereon by spin coating into a film thickness of 80 nm, to form a light-emitting layer. An electrode of Ca and Al respectively having thicknesses of 20 nm and 200 nm was formed on the coated substrate by vacuum deposition, to give an organic EL element 1.

### EXAMPLE 2

On a cleaned glass plate having a ITO electrode, PEDOT/PSS [poly(3,4-ethylenedioxy)-2,5-thiophene/polystyrenesulfonic acid] was coated by spin coating into a film thickness of 40 nm, and a solution of the copolymer P-1 obtained in Preparative Example 1 and Ir(ppy)₃ (3%) and an electron transporting material [following compound (9)] (35%) dissolved in dichloroethane at a concentration of 1.0 wt % was coated thereon by spin coating into a film thickness of 80 nm, to form a light-emitting layer. An electrode of Ca and Al respectively having thicknesses of 20 nm and 200 nm was formed on the coated substrate by vacuum deposition, to give an organic EL element 2.

### Compound (9):

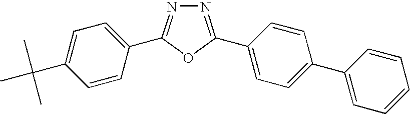

### EXAMPLE 3

On a glass plate having a cleaned ITO electrode, PEDOT/PSS [poly(3,4-ethylenedioxy)-2,5-thiophene/polystyrenesulfonicacid] was coated by spin coating into a film thickness of 40 nm, and a solution of the copolymer P-10 obtained in Preparative Example 2 and Ir(ppy)₃ (3%) and an electron transporting material [following compound (10)] (35%) dissolved in toluene at a concentration of 1.0 wt % was coated thereon by spin coating into a film thickness of 80 nm, to give a light-emitting layer. An electrode of Ca and Al respectively having thicknesses of 20 nm and 200 nm was formed on the coated substrate by vacuum deposition, to give an organic EL element 3.

### Compound (10):

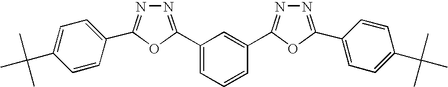

### EXAMPLE 4

On a glass plate having a cleaned ITO electrode, PEDOT/PSS [poly(3,4-ethylenedioxy)-2,5-thiophene/polystyrenesulfonic acid] was coated by spin coating into a film thickness of 40 nm, and a solution of the copolymer P-17 obtained in Preparative Example 5 and Ir(ppy)₃ (3%) dissolved in dichloroethane at a concentration of 1.0 wt % was coated thereon by spin coating into a film thickness of 80 nm, to form a light-emitting layer. An electrode of Ca and Al respectively having thicknesses of 20 nm and 200 nm was formed on the coated substrate by vacuum deposition, to give an organic EL element 4.

### EXAMPLE 5

On a glass plate having a cleaned ITO electrode, PEDOT/PSS (poly(3,4-ethylenedioxy)-2,5-thiophene/polystyrenesulfonic acid) was coated by spin coating into a film thickness of 40 nm, and a solution of the copolymer P-12 obtained in Preparative Example 3 and Ir(Me-ppy)₃ (6%) dissolved in toluene at a concentration of 1.0 wt % was coated thereon by spin coating into a film thickness of 80 nm, to form a light-emitting layer. An electrode of CsF and Al respectively having thicknesses of 1 nm and 200 nm was formed on the coated substrate by vacuum deposition, to give an organic EL element 5.

### EXAMPLE 6

On a glass plate having a cleaned ITO electrode, PEDOT/PSS [poly(3,4-ethylenedioxy)-2,5-thiophene/polystyrenesulfonic acid] was coated by spin coating into a film thickness of 40 nm, and a solution of the copolymer P-15 obtained in Preparative Example 4 and Ir(t-Bu-ppy)₃ (6%) dissolved in toluene at a concentration of 1.0 wt % was coated thereon by spin coating into a film thickness of 80 nm, to form a light-emitting layer. An electrode of Ca and Al respectively having thicknesses of 20 nm and 200 nm was formed on the coated substrate by vacuum deposition, to give an organic EL element 6.

### EXAMPLE 7

On a glass plate having a cleaned ITO electrode, PEDOT/PSS [poly(3,4-ethylenedioxy)-2,5-thiophene/polystyrenesulfonic acid] was coated by spin coating into a film thickness of 40 nm, and a solution of the copolymer P-18 shown in Table 1 and Ir(ppy)₃ (3%) dissolved in dichloroethane at a concentration of 1.0 wt % was coated thereon by spin coating into a film thickness of 80 nm, to form a light-emitting layer. An electrode of Ca and Al respectively having thicknesses of 20 nm and 200 nm was formed on the coated substrate by vacuum deposition, to give an organic EL element 7.

### EXAMPLE 8

On a glass plate having a cleaned ITO electrode, PEDOT/PSS [poly(3,4-ethylenedioxy)-2,5-thiophene/polystyrenesulfonic acid] was coated by spin coating into a film thickness of 40 nm, and a solution of the copolymer P-19 shown in Table 1 and Ir(ppy)₃ (3%) dissolved in dichloroethane at a concentration of 1.0 wt % was coated thereon by spin coating into a film thickness of 80 nm, to form a light-emitting layer. An electrode of Ca and Al respectively having thicknesses of 20 nm and 200 nm was formed on the coated substrate by vacuum deposition, to give an organic EL element 8.

### EXAMPLE 9

On a glass plate having a cleaned ITO electrode, PEDOT/PSS [poly(3,4-ethylenedioxy)-2,5-thiophene/polystyrenesulfonic acid] was coated by spin coating into a film thickness of 40 nm, and a solution of the copolymer P-20 obtained in Preparative Example 6 and Ir(ppy)₃ (6%) dissolved in dichloroethane at a concentration of 1.0 wt % was coated thereon by spin coating into a film thickness of 70 nm, to form a light-emitting layer. An electrode of Ca and Al respectively having thicknesses of 20 nm and 200 nm was formed on the coated substrate by vacuum deposition, to give an organic EL element 9.

### COMPARATIVE EXAMPLES 1 TO 4

An element using the following copolymer (11) or the following single polymer (12) instead of the copolymer P-1 of Example 2 was prepared and designated as an element 10 or 11 (Comparative Example 1 or 2). Separately, an element using the copolymer (11) or the single polymer (12) instead of the copolymer P-10 in the light-emitting layer of Example 3 was prepared and designated as an element 12 or 13 (Comparative Example 3 or 4). The copolymer (11) and the single polymer (12) are described in the Patent Document 3.

### Copolymer (11):

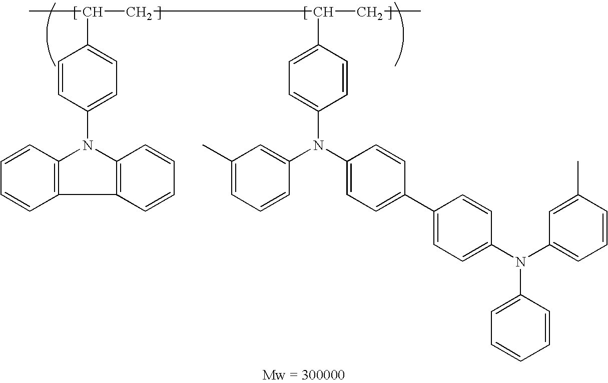

### Single Polymer (12):

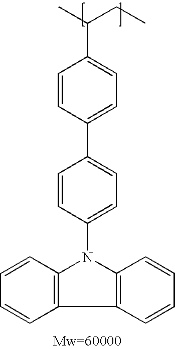

EL characteristics of the organic EL elements obtained in Examples 1 to 9 and Comparative Examples 1 to 4 are summarized in Table 2. The brightness and the efficiency were determined and calculate according to the following <measurement of brightness> and <calculation of efficiency>.

### <Measurement of Brightness>

The brightness was measured by using a color brightness meter CS-100A manufactured by Minolta.

### <Calculation of Efficiency>

The efficiency was determined by measuring the voltage and the current during emission of an EL element by using a power source R6243 manufactured by Advantech and calculating according to the following known equation.

Current efficiency(cd/A)=Brightness(cd/cm²)/Current density(mA/cm²)×10

Power efficiency(lm/W)=τ×Brightness(cd/cm²)×Light-emitting area(m²)/Voltage (V)×Current density(mA/cm²)×10

TABLE 2

| | | Material of | | |
|---|---|---|---|---|
| | | light-emitting | Brightness | Efficiency |
| | Element No. | layer | (8 V) | (lm/W) |
| Example 1 | Element 1 | P-1 | 20 | 5.1 |
| Example 2 | Element 2 | P-1 | 500 | 8.2 |
| Comparative | Element 10 | Copolymer (11) | 300 | 4.0 |
| Example 1 | | | | |
| Comparative | Element 11 | Single polymer | 2.0 | 4.5 |
| Example 2 | | (12) | | |
| Example 3 | Element 3 | P-10 | 650 | 12.6 |
| Comparative | Element 12 | Copolymer (11) | 200 | 5.0 |
| Example 3 | | | | |
| Comparative | Element 13 | Single polymer | 1.0 | 6.0 |
| Example 4 | | (12) | | |
| Example 4 | Element 4 | P-17 | 180 | 7.5 |
| Example 5 | Element 5 | P-12 | 150 | 12.4 |
| Example 6 | Element 6 | P-15 | 210 | 8.3 |
| Example 7 | Element 7 | P-18 | 150 | 6.5 |
| Example 8 | Element 8 | P-19 | 120 | 5.9 |
| Example 9 | Element 9 | P-20 | 200 | 8.2 |

As apparent from the comparison among the characteristics shown in Table 2, the electroluminescent elements (elements 2 and 3) using the material for organic electroluminescent elements according to the present invention are lower in driving voltage and higher in emission efficiency than the electroluminescent elements (elements 10, 11, 12 and 13) using a conventionally known copolymer (11) or single polymer (12).

The organic electroluminescent element according to the present invention allows reduction in driving voltage and improvement in luminous efficiency and luminescence brightness, and the Examples above are not intended to restrict the emitting material, auxiliary emitting material, positive hole transporting material, electron transporting material, sensitizer, resin, electrode material, and others as well as the method of producing the device for use in the present invention.

1. A material for organic electroluminescent elements, characterized by including a copolymer having the unit represented by the following General Formula [1] and an amino group-containing unit.
General Formula [1]: 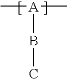
wherein A represents an unconjugated trivalent organic residue; B represents a bivalent organic residue formed by binding conjugately two or more groups selected from the group consisting of substituted or unsubstituted arylene groups and substituted or unsubstituted heteroarylene groups to each other; and C represents a monovalent organic residue represented by the General Formula [2]: 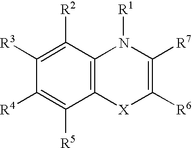
wherein R¹ to R⁷ each represents a binding unit, a hydrogen atom or a substituent; X represents a direct bond, —O—, —S—, —Se—, —NH—, —NR⁸— (R⁸ represents an alkyl or aryl group.), —S(═O)₂—, —CO—, —COO—, —OCO—, or —CH₂—; and R¹ to R⁷ may bind to each other to form an aryl ring that may have additionally substituents.

2. The material for organic electroluminescent elements according to claim 1, being characterized in that the monovalent organic residue represented by General Formula [2] is a monovalent organic residue represented by the General Formula [3]: 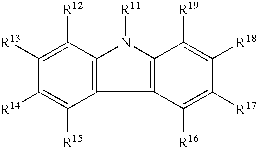
wherein R¹¹ to R¹⁹ each represents a binding unit, a hydrogen atom or a substituent.

3. The material for organic electroluminescent elements according to claim 1 or 2, being characterized in that the copolymer has additionally a unit represented by the General Formula [7]: 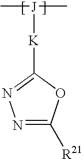
wherein J represents an unconjugated trivalent organic residue; K represents a direct bond, a bivalent organic residue selected from the group consisting of substituted or unsubstituted arylene groups and substituted or unsubstituted heteroarylene groups, and a bivalent organic residue formed by binding two or more groups selected from the group consisting of the substituted or unsubstituted arylene groups, the substituted or unsubstituted heteroarylene groups, and substituted or unsubstituted ethenylene groups to each other, and when the substituted or unsubstituted ethenylene group is used, the ethenylene group is put between the arylene group(s) and/or heteroarylene group(s); and R²¹ represents a hydrogen atom or a substituent.

4. The material for organic electroluminescent elements according to any one of claims 1 to 3, being characterized in that the copolymer has additionally at least one unit selected from a unit derived from N-vinylcarbazole or a N-vinylcarbazole derivative, a unit derived from styrene or a styrene derivative, a unit derived from (meth) acrylic acid or a (meth)acrylic acid derivative, a unit derived from maleic acid or a maleic acid derivative, and a unit derived from an organic acid vinyl ester.

5. The material for organic electroluminescent elements according to any one of claims 1 to 4, further including a luminescent material capable of emitting light based on the triplet exciton.

6. The material for organic electroluminescent elements according to any one of claims 1 to 5, further including an electron transporting material.

7. An organic electroluminescent element having a light-emitting layer or multiple layers of organic compound thin films including a light-emitting layer between a pair of electrodes, wherein at least one of the layers includes the material for organic electroluminescent elements according to any one of claims 1 to 6.
